(19) United States
(12) Patent Application Publication
(10) Pub. No.: US 2026/0149641 A1
(43) Pub. Date: May 28, 2026

(54) SYSTEMS AND METHODS FOR ENHANCED NETWORK FUNCTION ANALYTICS AND FAILOVER IN A WIRELESS NETWORK

(71) Applicant: Verizon Patent and Licensing Inc., Basking Ridge, NJ (US)

(72) Inventors: Ravi Potluri, Coppell, TX (US); Myron Eugene Bagwell, Southlake, TX (US); Jerry Steben, Forth Worth, TX (US); Maqbool Chauhan, Keller, TX (US); Emerando M. Delos Reyes, Pleasant Hill, CA (US)

(73) Assignee: Verizon Patent and Licensing Inc., Basking Ridge, NJ (US)

(21) Appl. No.: 19/225,050

(22) Filed: Jun. 2, 2025

Related U.S. Application Data
(63) Continuation-in-part of application No. 18/956,797, filed on Nov. 22, 2024.

(51) Int. Cl. H04L 41/0895; H04L 41/14; H04L 43/0817; H04W 64/00

(52) U.S. Cl. CPC H04L 41/0895; H04L 41/145; H04L 43/0817; H04W 64/003

(57) ABSTRACT

A system described herein may identify an association between a particular container, of a containerized environment, with a particular Virtualized Network Function (“VNF”) of a wireless network; receive, via a control plane of the containerized environment, operational status monitoring information associated with the particular container; generate operational status monitoring information associated with the particular VNF based on the operational status monitoring information associated with the particular container; and output the operational status monitoring information, associated with the particular VNF, to an analytics element of the wireless network, wherein the analytics element provides the operational status monitoring information, associated with the particular VNF, to one or more other NFs of the wireless network. A coordinated failover of multiple different types of Network Functions (“NFs”) may be performed based on the operational status information for the particular VNF.

### CROSS-REFERENCE TO RELATED APPLICATION

This Application is a Continuation-in-Part of U.S. patent application Ser. No. 18/956,797, filed on Nov. 22, 2024, titled “SYSTEMS AND METHODS FOR ENHANCED CENTRALIZED UNIT FAILOVER IN A WIRELESS NETWORK,” the contents of which are herein incorporated by reference in their entirety.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. A wireless network may include one or more radio access networks (“RANs”) and one or more core networks. A RAN may serve as a wireless interface between UEs and a core network, and the core network may provide services such as routing services (e.g., routing traffic between UEs and one or more other devices or networks), Quality of Service (“QoS”) management services, mobility services, or the like. A RAN may include network functions (“NFs”) that facilitate the providing of wireless connectivity to UEs, such as Distributed Units (“DUs”), Centralized Units (“CUs”), and/or other NFs, that aggregate and/or forward traffic between UEs and a core network. A core network may include a gateway, such as a User Plane Function (“UPF”), that aggregates and/or forwards traffic between UEs and one or more other devices or networks, such as the Internet. Some wireless networks implement NFs in a containerized and/or virtualized manner (e.g., as Cloud-Native Network Functions (“CNFs”), Virtualized Network Functions (“VNFs”), or the like), in which NFs are implemented using virtual machines, containers, cloud systems, or the like.

### BRIEF DESCRIPTION OF THE DRAWINGS

FIG. 1 illustrates an example environment in which one or more embodiments, described herein, may be implemented;

FIG. 2 illustrates an example configuration of NF instances of a particular domain as primary NF instances, in accordance with some embodiments;

FIG. 3 illustrates an example coordinated failover of multiple types of NFs, in accordance with some embodiments;

FIG. 4 illustrates an example failover scenario in which a coordinated failover is not performed;

FIG. 5 illustrates an example configuration of respective NF instances as primary or backup NF instances, in accordance with some embodiments;

FIG. 6 illustrates example communications between CUs and a Network Repository Function (“NRF”), in accordance with some embodiments;

FIG. 7 illustrates an example coordinated failover of multiple types of NFs, including a UPF and a CU, based on failure or unavailability of the CU, in accordance with some embodiments;

FIG. 8 illustrates an example process for a CU communicating with an NRF to, for example, implement a coordinated failover procedure of multiple different types of NFs, in accordance with some embodiments;

FIG. 9 illustrates an example overview of one or more embodiments described herein;

FIG. 10 illustrates an example of associating a VNF with a container in a containerized environment, in accordance with some embodiments;

FIG. 11 illustrates an example of granular VNF operational status monitoring, in accordance with some embodiments;

FIG. 12 illustrates an example of performing a coordinated failover of a set of NFs based on granular operational status monitoring, in accordance with some embodiments;

FIG. 13 illustrates an example process for granular VNF operational status monitoring in a wireless network, in accordance with some embodiments;

FIGS. 14 and 15 illustrate example environments in which one or more embodiments, described herein, may be implemented;

FIG. 16 illustrates an example arrangement of a RAN, in accordance with some embodiments; and

FIG. 17 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

A wireless network may include a RAN, which may provide a wireless interface between UEs and a core network of the wireless network. The core network may provide routing services, QoS management services, and/or other services. The core network may, for example, forward traffic received from UEs, via a RAN, to a Data Network (“DN”), which may include the Internet and/or one or more other types of networks. Similarly, the core network may forward traffic, received from the DN, to a given UE via the RAN. The RAN may include NFs such as one or more radio units (“RUs”), DUs, and/or CUs, which may provide a routing path for user plane traffic sent to or from UEs that are wirelessly connected to the RAN. The core network may include a gateway, such as a UPF, which provides routing services (e.g., routing user plane traffic between UEs and a DN) and/or other services for user plane traffic sent to or from one or more UEs.

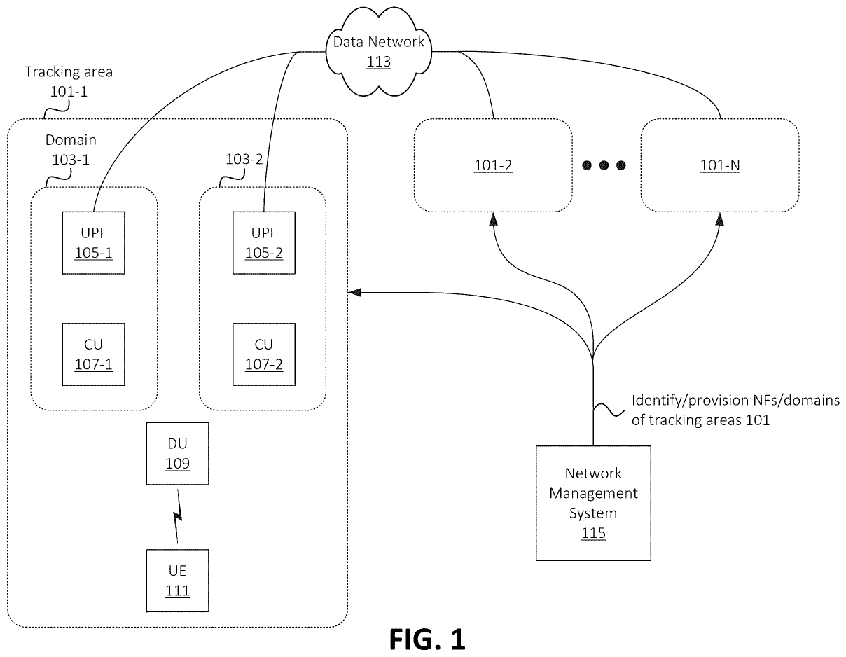

NFs of the wireless network, such as CUs and UPFs, may be implemented in a virtualized or containerized manner, in which a given NF may be provisioned, instantiated, etc. on various sets of hardware resources or virtual machines in a flexible and/or distributed manner. For example, as shown in FIG. 1, a network may include multiple tracking areas 101 (e.g., example tracking areas 101-1, 101-2, and 101-N). Each tracking area 101 may be associated with a particular geographical region such as a state, a province, a city, a neighborhood, or some other suitable type of geographical region. Additionally, or alternatively, a tracking area may refer to or may represent one or more respective coverage areas of one or more cells, base stations, or other wireless network infrastructure equipment of a RAN.

In some implementations, each tracking area 101 may include one or more domains 103. For example, tracking area 101-1 may include example domains 103-1 and 103-2. Different domains 103, as used herein, may refer to logical domains, domain name names or identifiers, different geographical regions (e.g., sub-regions of a geographical region represented by a particular tracking area 101 that includes multiple domains 103), or other example types or denotations of domains. In some embodiments, different domains 103 may refer to different sets of hardware resources used to implement NFs associated with each domain 103. For example, a first domain 103-1 may be implemented by a first set of hardware resources (e.g., a first datacenter, a first set of co-located devices or systems, a first cloud system, or the like), and a second domain 103-2 may be implemented by a second set of hardware resources (e.g., a second datacenter, a second set of co-located devices or systems, a second cloud system, or the like). In some embodiments, domain 103-1 may be or may include a first cluster (e.g., a Kubernetes® cluster, a group of nodes, and/or some other type of arrangement that is managed or configured by a particular management platform, controller, or the like), while domain 103-2 may be or may include a second cluster that is distinct from domain 103-1 (e.g., may be managed by a different management platform, controller, etc.).

In some embodiments, domains 103 may each be associated with a respective set of Quality of Service (“QoS”) thresholds (e.g., maximum latency thresholds or other suitable thresholds), Service Level Agreements (“SLAs”), or the like. For example, NFs of domain 103-1 may implement and/or operate according to a particular maximum latency threshold, such as by being implemented by hardware resources that are co-located and/or that otherwise implement mechanisms to meet the particular maximum latency threshold. In some situations, the latency threshold may not be guaranteed or may not otherwise be implemented in inter-domain communications, such as communications between CU 107-1 and UPF 105-2 of domain 103-2. Such latency threshold may not be guaranteed in implementations where, for example, domains 103-1 and 103-2 do not coordinate or cooperatively implement the particular latency threshold.

In some implementations, each domain 103 may include or may represent a respective group of NFs associated with a RAN and/or a core network. For example, domain 103-1 may include a first group of NFs that includes one or more core network NFs such as UPF 105-1 and one or more RAN NFs such as CU 107-1. While UPF 105 and CU 107 are discussed herein as example NFs include in respective domains 103, such domains 103 may include one or more additional types of core network and/or RAN NFs. The NFs of each domain 103 may be referred to as “instances” of such NFs. For example, UPF 105-1 may be a first UPF instance, and UPF 105-2 may be a second UPF instance. Similarly, CU 107-1 may be a first CU instance and CU 107-2 may be a second CU instance. In some embodiments, NFs of different domains 103 may communicate with each other, such as control and/or synchronization signaling. Such communications may include, in some implementations, a geo-redundancy (“GR”) channel, an application programming interface (“API”), and/or some other suitable type of communication pathway.

Each domain may include one or more DUs 109, which may perform baseband processing and/or other types of processing based on wireless communications with one or more UEs 111. For example, DU 109 may include or may be communicatively coupled to wireless hardware such as a radio unit (“RU”), one or more antennas, one or more radios, or the like, via which DU 109 may wirelessly send and/or receive traffic to and/or from UE 111. DU 109 may communicate with a given CU instance (e.g., CU 107-1 or 107-2) in order to facilitate connectivity between UE 111 and one or more other networks, such as DN 113.

In some embodiments, tracking areas 101, domains 103, and/or NFs associated therewith may be provisioned, instantiated, configured, identified, monitored, etc. by Network Management System (“NMS”) 115. NMS 115 may be, may include, or may be communicatively coupled to an administrator system, a containerization platform, a cloud computing configuration system, or some other type of system. NMS 115 may, for example, provision hardware resources, virtual machines, containers, or the like to implement respective NFs or NF instances. In some embodiments, NMS 115 may include a containerization system controller, and respective NF instances may be instantiated on nodes that are configured by the containerization system controller.

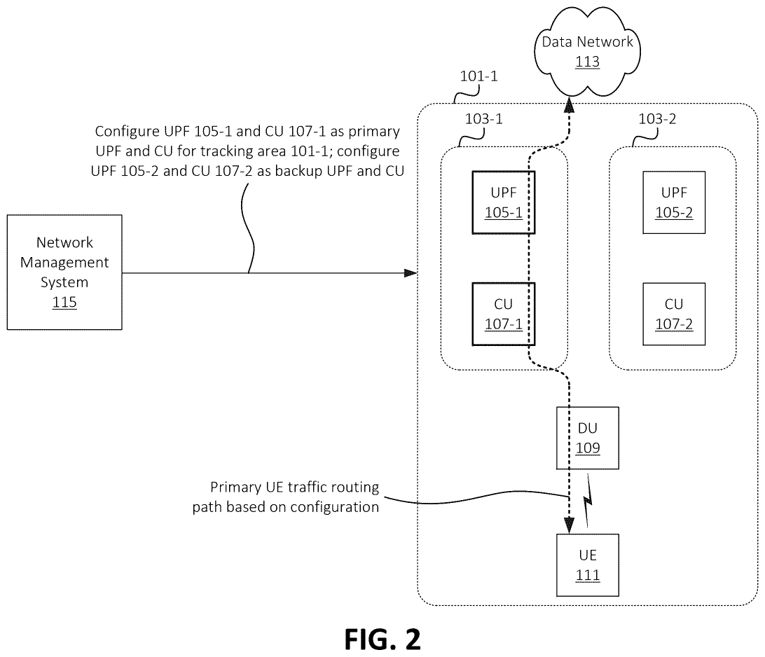

In some embodiments, NMS 115 may assign “primary” or “backup” status to NFs of respective domains 103. For example, as shown in FIG. 2, NMS 115 may assign NFs of domain 103-1 (e.g., UPF 105-1 and CU 107-1) as primary NFs, and may assign NFs of domain 103-2 (e.g., UPF 105-2 and CU 107-2) as backup NFs.

As discussed herein, configuring tracking area 101 may include establishing a communication pathway between CUs 107 and one or more other core network NFs, such as an NRF. In some embodiments, the NRF may maintain information indicating primary NFs, backup NFs, and/or other information that may be used to route communications within respective tracking areas 101 (e.g., information based on which traffic may be routed via particular domains 103). In some embodiments, multiple CU instances (e.g., multiple CUs 107) may subscribe to information pertaining to each other, such as priority information (e.g., primary, backup, etc.) maintained by NRF. For example, CU 107-1 may subscribe to information pertaining to CU 107-2, and CU 107-2 may subscribe to information pertaining to CU 107-1. Additionally, in some embodiments, the NRF may subscribe to operational status monitoring information associated with multiple CUs 107, in which CUs 107 periodically, intermittently, and/or in some other ongoing manner, provide operational status monitoring information to the NRF. In some embodiments, CUs 107 and the NRF may communicate via a Service-Based Interface (“SBI”), such as via an Nnrf SBI.

Configuring tracking area 101-1 may include indicating to the NFs of tracking area 101 and/or to one or more routing devices of tracking area 101-1 that UPF 105-1 is a primary UPF and that CU 107-1 is a primary CU. The one or more routing devices of a given tracking area 101 may include a routing mesh, routers, hubs, switches, or other network devices that facilitate communications between NFs of each domain 103, as well as inter-domain communications between different domains 103 of tracking area 101. The routing devices of tracking area 101 may be configured (e.g., by NMS 115) to route communications, associated with a given type of NF, to a particular NF instance. For example, the routing devices may be configured to route communications via NFs designated as “primary” to UPF 105-1 and/or CU 107-1. The example routing path shown in FIG. 2, for example, traverses NFs of domain 103-1 such as UPF 105-1 and CU 107-1, in order to facilitate connectivity between UE 111 and DN 113.

In other implementations, other types of rules or policies may be used to indicate whether to route respective communications via NFs of a given domain 103. As such, while the examples described herein with respect to “primary” or “backup” designations are provided for the sake of example, some embodiments may be implemented with respect to other types of traffic routing rules or policies.

The establishment and implementation of domains 103 may allow for the delivery or implementation of QoS thresholds or SLAs, and/or may otherwise serve to reduce latency of communications between UE 111 and DN 113. For example, as discussed above, different domains 103 may be implemented by different respective sets of hardware resources and/or may otherwise implement particular QoS thresholds or SLAs. As such, communications that traverse NFs of one domain 103 (e.g., domain 103-1, as shown here) may provide for reduced latency, or otherwise preferential measures of performance, as compared to inter-domain communications that traverse NFs of multiple domains 103.

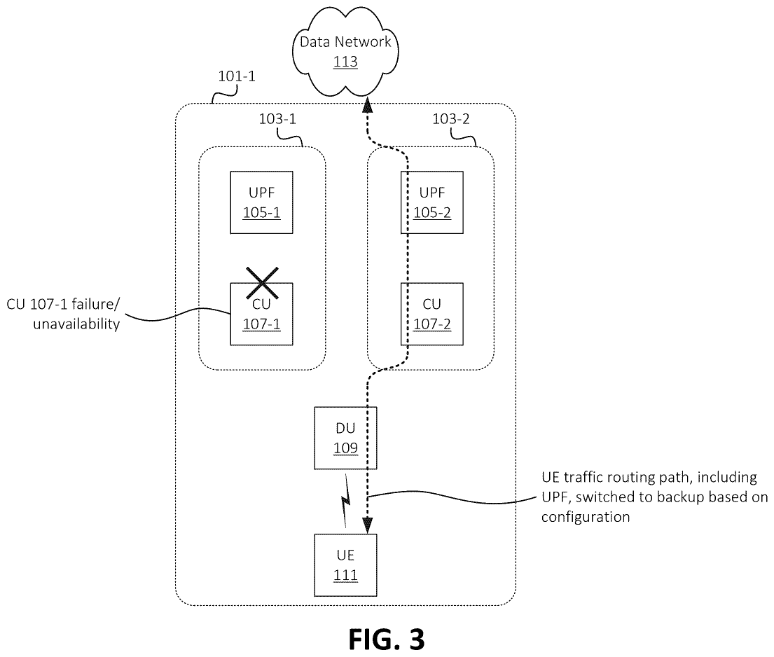

Embodiments described herein provide for a failover mechanism that performs failover operations on a per-domain basis, such as in situations where a given NF of a given domain 103 fails, becomes unavailable, becomes overloaded, or is otherwise unable to provide the functionality of the NF. For example, as shown in FIG. 3, a condition may occur in which CU 107-1 has failed or has otherwise become unavailable. The failure or unavailability of CU 107-1 may be independent of the operational status of UPF 105-1. For example, CU 107-1 may have failed, while UPF 105-1 remains operational or in a nominal status.

The failover mechanism of some embodiments may provide for a failover of multiple NFs of a given domain 103 when one NF of the domain fails. For example, in accordance with some embodiments, a UE traffic routing path, between UE 111 and DN 113, may be switched or failed over to include NFs of domain 103-2 (e.g., UPF 105-2 and CU 107-2) in a situation where CU 107-1 has failed. As discussed below, this failover mechanism may include a communication pathway (e.g., one or more SBIs or other suitable communication pathways) between CUs 107 and an NRF, via which CUs 107 and the NRF exchange information such as operational status monitoring information and/or priority information.

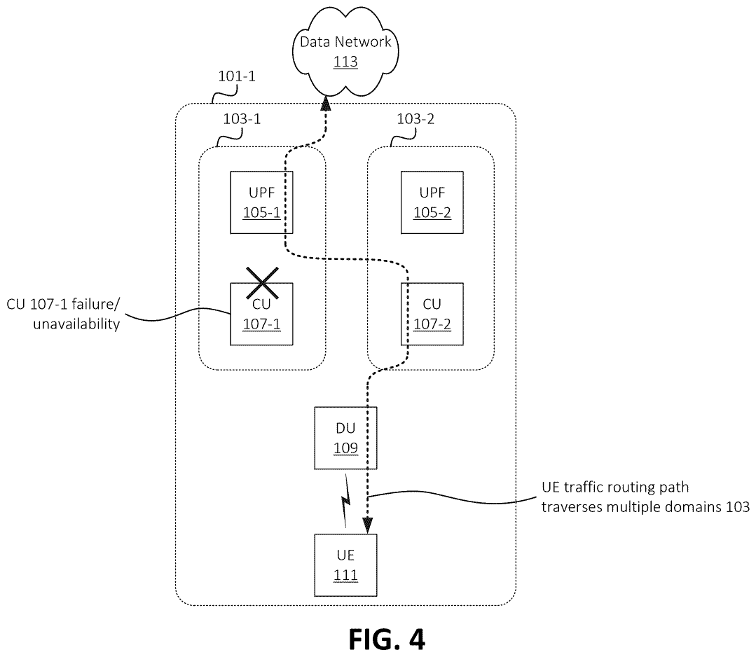

This domain-based failover mechanism of some embodiments may aid in avoiding situations in which a routing path for UE traffic traverses multiple domains 103. For example, as shown in FIG. 4, one such scenario involves CU 107-1 failing while UPF 105-1 remains operational. In some situations, this scenario may include a failover of CU 107-1 to CU 107-2 (e.g., in which CU 107-2 is designated as the primary CU instance), but no failover or transfer of the functionality of UPF 105-1 to another UPF, such as UPF 105-2. As a result, UE traffic may traverse multiple domains 103-1 and 103-2. As discussed above, this inter-domain communication may, in some circumstances, introduce measures of delay or may otherwise impact performance, in contrast to routing paths that stay within a given domain 103.

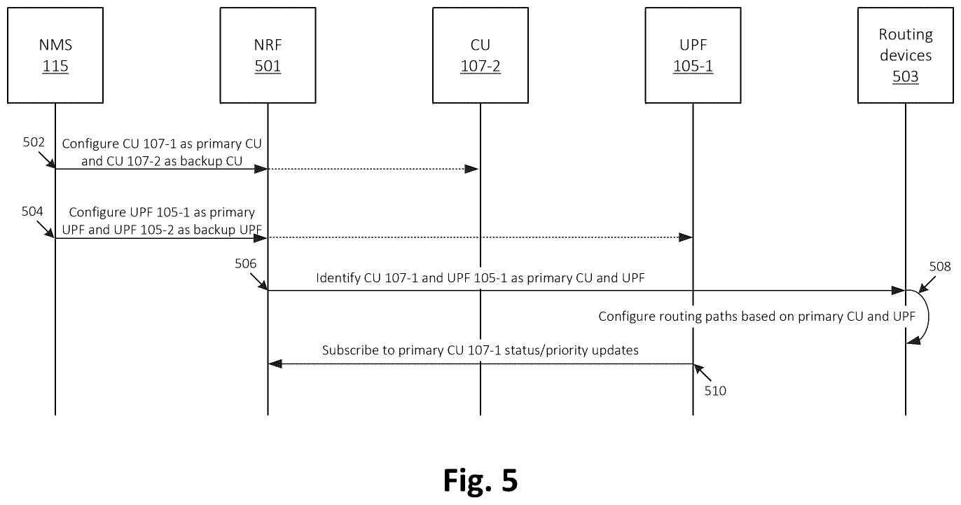

FIG. 5 illustrates an example signal flow for configuring NFs of a wireless network, such as one or more core network NFs such as UPF 105 (e.g., one or more UPF instances) and one or more RAN NFs such as CU 107 (e.g., one or more CU instances). As noted above, the configuration may include designating routing rules or policies, such as a designation of one or more “primary” and/or “backup” NF instances. In this example, NFs of domain 103-1 (e.g., UPF 105-1 and CU 107-1) may be designated (e.g., by NMS 115) as “primary” NF instances, and NFs of domain 103-2 (e.g., UPF 105-2 and CU 107-2) may be designated as “backup” NF instances. As shown, NMS 115 may provide (at 502), to NRF 501 and/or CU 107-2, an indication that CU 107-1 is a primary CU (e.g., is associated with a “primary” priority) and/or that CU 107-2 is a backup CU.

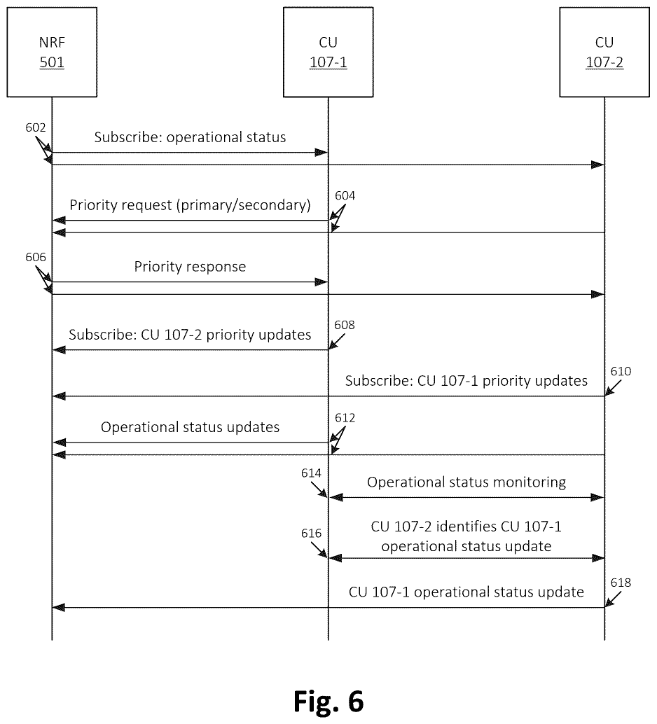

FIG. 6 illustrates an example of communications between NRF 501 and one or more CUs 107 (e.g., CUs 107-1 and 107-2), in accordance with some embodiments, based on the configuration of CUs 107-1 and 107-2 as primary and backup NF instances, respectively. As discussed above, CUs 107 may communicate with NRF 501 via an Nnrf SBI or via some other suitable communication pathway. As shown, NRF 501 may subscribe (at 602) to operational status information associated with CUs 107-1 and 107-2. For example, in some embodiments, NRF 501 may output requests, to CUs 107-1 and 107-2, for operational status monitoring information, such as an availability indication (e.g., “available” or “unavailable”), performance or load metrics (e.g., processor load, network load, etc.), or other suitable operational status information. Additionally, or alternatively, NRF 501 may output such requests to some other device or system that monitors or provides operational status monitoring information associated with CUs 107-1 and 107-2. For example, as discussed below, NRF 501 may output such requests to a Network Data Analytics Function (“NWDAF”), which may monitor and/or generate operational status information on a per-NF instance basis, on a per-domain basis, on a per-geographical location basis, or some other suitable basis.

CUs 107-1 and/or 107-2 may request (at 604), from NRF 501, a request for priority information. For example, CUs 107-1 and 107-2 may output one or more messages via an Nnrf SBI requesting such information. NRF 501 may provide (at 606) the requested priority information, which may include an indication of which CU is a primary CU instance and/or which CU is a backup CU instance. For example, CU 107-2 may receive information indicating that CU 107-1 is a primary CU and/or that CU 107-2 is a backup CU. Additionally, CU 107-1 may receive information indicating that CU 107-1 is a primary CU and/or that CU 107-2 is a backup CU.

CUs 107 may subscribe to priority updates associated with other CUs 107. A priority update may refer to, for example, the change in priority of a given CU (e.g., from primary to backup or vice versa). For example, CU 107-1 may subscribe (at 608) to priority updates associated with CU 107-2, and CU 107-2 may subscribe (at 610) to priority updates associated with CU 107-1. Additionally, in some embodiments, CUs 107 may subscribe to priority updates associated with themselves (e.g., CU 107-1 may subscribe to priority updates associated with CU 107-1 and CU 107-2 may subscribe to priority updates associated with CU 107-2). As discussed above, NRF 501 may, in some embodiments, receive priority information from NMS 115 and/or some other suitable source.

As shown, CUs 107-1 and 107-2 may provide (at 612) operational status updates to NRF 501, based on the subscribing (at 602) of NRF 501 to CU operational status updates. For example, when CU 107-1 determines a change to its operational status (e.g., from “available” to “unavailable,” “not overloaded” to “overloaded,” etc.), CU 107-1 may provide (at 612) an indication to NRF 501 of the operational status change.

CUs 107 may further communicate (at 614) with each other, such as via a GR channel, to provide operational status monitoring information to each other. For example, in some situations, CU 107-2 may identify (at 616) an operational status update associated with CU 107-1, such as an identification that CU 107-1 has failed or has become unavailable. In such scenarios, CU 107-2 may provide (at 618) an operational status update, associated with CU 107-1, to NRF 501. In some embodiments, NMS 115 and/or some other device or system may monitor the operational status of CUs 107, and may provide such updated information to NRF 501. In this sense, NRF 501 may maintain, in real time or near-real time, operational status information, priority information, and/or other information associated with CUs 107.

Returning to FIG. 5, NMS 115 may configure (at 504) primary and backup UPF instances. For example, NMS 115 may provide information to NRF 501, UPF 105-1, and/or other NFs, indicating that UPF 105-1 is a primary UPF instance and/or that UPF 105-2 is a secondary UPF instance. In some embodiments, UPFs 105-1 and 105-2 may communicate (e.g., via a GR channel or other suitable communication pathway) with each other to identify themselves as respective primary or backup UPF instances. In some embodiments, UPFs 105-1 and/or 105-2 may identify priority information based on information maintained or provided by NRF 501. For example, NRF 501 may receive priority information associated with UPFs 105-1 and/or 105-2, and may provide such information to UPFs 105-1 and/or 105-2. In this manner, or in some other manner, UPF 105-1 may identify that UPF 105-1 is a primary UPF instance and that UPF 105-2 is a particular UPF instance (e.g., out of a group of potential UPF instances) that is a backup instance with respect to UPF 105-1. In some embodiments, UPF 105-1 may receive communication information associated with UPF 105-2 from NRF 501. Such communication information may include, for example, an Internet Protocol (“IP”) address of UPF 105-2, a hostname associated with UPF 105-2, and/or some other suitable identifier or communication information associated with UPF 105-2.

As further shown, one or more routing devices 503 (e.g., routing devices of the same tracking area 101 with which UPF 105-1, UPF 105-2, CU 107-1, and CU 107-2 are associated) may identify (at 506) UPF 105-1 and CU 107-1 as a primary UPF and CU of tracking area 101. Routing devices 503 may configure (at 508) routing paths of tracking area 101 based on the identification that UPF 105-1 and CU 107-1 are the primary UPF and CU of tracking area 101. In situations where UPF 105-1 and CU 107-1 are in the same domain (e.g., domain 103-1), the configuration of the routing paths may cause UE traffic to traverse NFs of one domain rather than allowing for scenarios where such traffic traverses NFs of multiple domains, as discussed above. For example, routing devices 503 may route UPF-directed traffic to UPF 105-1 (e.g., instead of to UPF 105-2) and may route CU-directed traffic to CU 107-1 (e.g., instead of to CU 107-2).

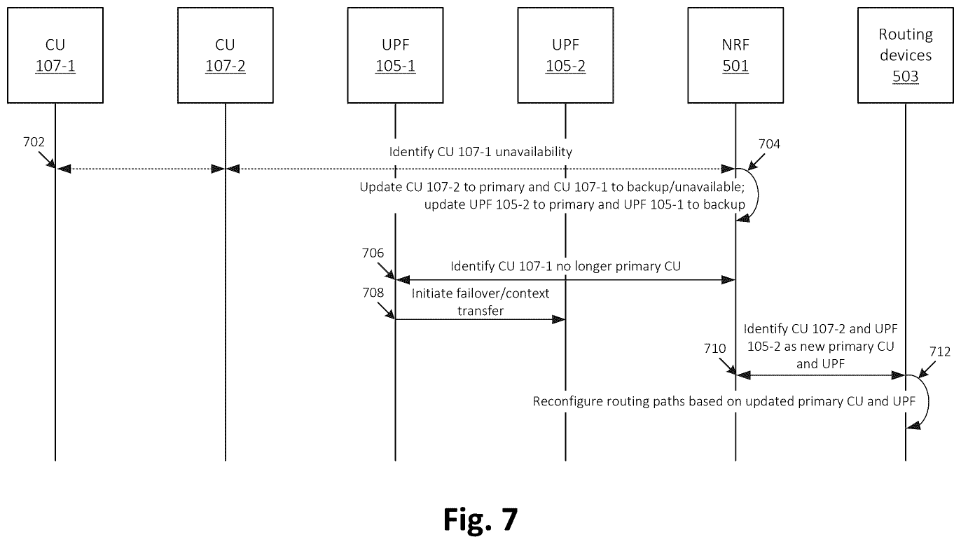

FIG. 7 illustrates an example scenario in which CU 107-1 fails, becomes unreachable, becomes unavailable, indicates an overload condition, and/or is otherwise unable to provide a given set of functionality (referred to herein as becoming “unavailable,” for the sake of conciseness). As shown, NRF 501 may identify (at 702) that CU 107-1 has become unavailable. For example, as discussed above with respect to FIG. 6, NRF 501 may receive an indication from CU 107-1 that CU 107-1 has become unavailable (e.g., such as in a situation where CU 107-1 is operational but overloaded), may receive an indication from CU 107-2 that CU 107-1 is unavailable (e.g., CU 107-2 may determine that CU 107-1 is non-responsive to messages sent to CU 107-1), and/or may receive an indication from some other device or system (e.g., NMS 115, a RAN controller, or some other device or system that monitors the operational status of CU 107-1) that CU 107-1 is unavailable.

NRF 501 may update (at 704) priority information associated with UPF 105-1, UPF 105-2, CU 107-1, and CU 107-2 based on the indication that CU 107-1 is unavailable. In other words, NRF 501 may update priority information associated with NFs of the primary domain 103-1 (e.g., which includes primary CU 107-1 which has become unavailable) as well as priority information associated with the backup domain 103-2. The updating may include modifying priority information associated with UPF 105-1 and CU 107-1 from “primary” to “backup” (or some other status such as “unavailable,” “failure,” etc.) and modifying priority information associated with UPF 105-2 and CU 107-2 from “backup” to “primary.”

In some embodiments, NRF 501 may be configured to modify the priority information for primary and backup NFs based on receiving operational status updates. For example, NRF 501 may be configured to identify backup NFs, such as CU 107-2 and its associated UPF 105-2, and designate such backup NFs as primary when the previously designated primary CU 107-1 becomes unavailable. In some embodiments, some other device or system may designate or redesignate priority information for NFs of tracking area 101, such as NMS 115. In such scenarios, NMS 115 may provide updated priority information to NRF 501, based on which NRF 501 may update the priority information maintained by NRF 501.

UPF 105-1 may identify (at 706) that CU 107-1 is no longer a primary CU instance. As discussed above, UPF 105-1 may have identified that UPF 105-1 and CU 107-1 were both configured as primary NF instances. Accordingly, when identifying that CU 107-1 is no longer a primary CU instance, UPF 105-1 may identify that UPF 105-1 is therefore no longer a primary UPF instance. As such, UPF 105-1 may have subscribed (at 510) to updates to the priority information associated with CU 107-1. Based on this subscription, NRF 501 may notify (at 706) UPF 105-1 that the priority of CU 107-1 has been changed (e.g., that CU 107-1 is no longer the primary CU instance), and/or UPF 105-1 may otherwise identify that CU 107-1 is no longer the primary CU instance.

UPF 105-1 may accordingly initiate (at 708) a failover procedure, a context transfer procedure, or the like with respect to UPF 105-2. For example, as noted above, UPF 105-1 may have identified (at 504) UPF 105-2 as a backup UPF instance, and may accordingly communicate with UPF 105-2 to facilitate a failover, transfer, etc. of the functionality of UPF 105-1 to UPF 105-2. In this manner, UPF 105-2 may continue to provide the functionality provided by UPF 105-1 (e.g., forwarding traffic between a core network and DN 113). Transferring the functionality may include providing configuration information, routing tables, Dynamic Host Configuration Protocol (“DHCP”) information, session information, UE information, or the like from UPF 105-1 to UPF 105-2. In some embodiments, the transfer of functionality from UPF 105-1 to UPF 105-2 may be performed or initiated in some other suitable manner. For example, in some embodiments, UPF 105-2 and/or some other device or system may output a request or command to UPF 105-1 to transfer its functionality to UPF 105-2.

In some embodiments, CU 107-2 may perform one or more operations based on identifying that CU 107-1 is no longer the primary CU instance, and/or based on identifying that CU 107-2 is the new primary CU instance. For example, CU 107-2 may output a request to NRF 501 for discovery information that includes communication information and/or an identifier of a primary UPF instance. In this scenario, NRF 501 may provide an identifier or other information associated with UPF 105-2, which has become the new primary UPF instance. In some embodiments, CU 107-2 (and/or some other device or system) may output a request or command to NRF 501, modifying a priority of CU 107-2 and/or of CU 107-1 based on identifying that CU 107-1 has failed and/or is no longer the primary CU instance. Such request or command may specify, for example, a higher priority for CU 107-2 than the priority of CU 107-1.

Routing devices 503 may identify (at 710) UPF 105-2 and CU 107-2 as the new primary UPF and CU instances, respectively. For example, routing devices 503 may periodically, intermittently, or on some other ongoing basis receive or monitor such information maintained by NRF 501, in order to identify changes to priority information or other routing information. Routing devices 503 may accordingly reconfigure (at 712) one or more routing paths based on the priority updates (e.g., the updating of UPF 105-2 and CU 107-2 as the new primary UPF and CU instances). For example, as shown in FIG. 3, in situations where UPF 105-2 and CU 107-2 are implemented as part of the same domain 103-2, the failover from UPF 105-1 and CU 107-1 to UPF 105-2 and CU 107-2 may include maintaining a single domain for routing UE traffic, thus maintaining QoS thresholds, SLAs, or other measures of performance or quality with respect to such traffic.

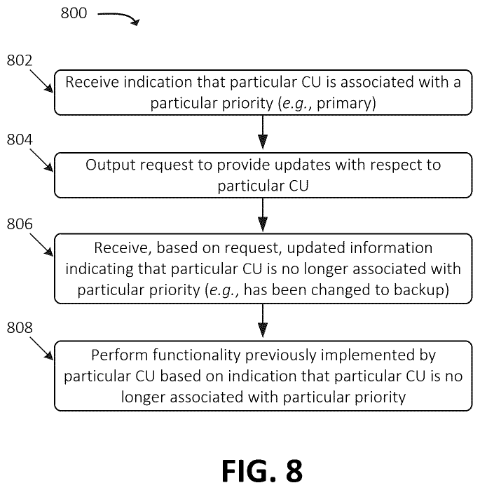

FIG. 8 illustrates an example process 800 for a particular CU 107 communicating with NRF 501, such as in implementations where the coordinated failover procedure of multiple different types of NFs (e.g., a given CU 107 and a given UPF 105) are performed based on communications between CU 107 and NRF 501. In some embodiments, some or all of process 800 may be performed by a particular CU 107, such as a particular CU 107 that has been designated as a backup CU instance for a given tracking area 101.

As shown, process 800 may include receiving (at 802) an indication that a given CU 107 is associated with a particular priority. For example, a backup CU instance (e.g., CU 107-2) may receive an indication that another CU instance (e.g., CU 107-1) has been associated with a “primary” priority. While priority (e.g., primary or backup) is discussed here as one example implementation, in some embodiments other types of labels, categories, rules, policies, identifiers, etc. may be used. The backup CU instance (e.g., CU 107-2) may, for example, receive the indication from NRF 501 and/or from some other suitable device or system, as discussed above.

Process 800 may further include outputting (at 804) a request to provide updates with respect to the particular CU 107 that is associated with the particular priority. For example, CU 107-2 may output a subscription request to NRF 501, indicating that CU 107-2 should be notified when the priority and/or other information of CU 107-1 changes, is updated, etc. For example, CU 107-2 may identify that CU 107-2 is a backup with respect CU instance to CU 107-1, and may accordingly request updated information associated with CU 107-1 from NRF 501 when NRF 501 receives such information.

Process 800 may additionally include receiving (at 806) updated information, indicating that the particular CU (e.g., CU 107-1) is no longer associated with the particular priority (e.g., the primary priority). For example, CU 107-1 may have failed, become overloaded, or may otherwise have become unavailable. NRF 501 may have received information (e.g., from NMS 115, from CU 107-1, from CU 107-2, and/or from some other source) indicating that CU 107-1 is unavailable. In some embodiments, NRF 501 may have updated priority information associated with CU 107-1 and/or CU 107-2, and/or may have received updated priority information associated with CU 107-1 and/or CU 107-2. As discussed above, the updated priority information may indicate that CU 107-1 is no longer a primary CU instance, that CU 107-1 is now a backup CU instance, that CU 107-2 is no longer a backup CU instance, and/or that CU 107-2 is now a primary CU instance.

As discussed above, one or more other NFs of the wireless network may identify the updated priority information associated with CU 107-1 and/or CU 107-2. For example, UPF 105-2 may identify or receive the updated priority information, routing devices 503 may identify or receive the updated priority information, and/or one or more other elements of the wireless network may identify or receive the updated priority information. As discussed above, CU 107-2 may perform (at 808) the functionality previously performed by CU 107-1 (e.g., may participate in a failover procedure whereby CU 107-2 assumes the role or functionality within the wireless network previously performed by CU 107-1). Additionally, other elements of the wireless network, such as UPF 105-2, routing devices 503, etc. may facilitate the modification of routing within the wireless network, such as the routing of UE traffic. As discussed above, the modified routing may include maintaining a single-domain routing topology, in which the UE routing path does not traverse multiple domains 103, thus preserving the delivery of QoS thresholds, SLAs, etc. for UE traffic.

In some embodiments, determining the availability or unavailability of one or more NFs (e.g., at 704), such as based on operational status monitoring, may be performed on a per-container basis, on a per-NF instance basis, on a per-location basis, on a per-domain basis, and/or on some other granular basis. For example, as discussed herein, some embodiments may provide enhanced analytics information on a per-container basis, on a per-NF instance basis, on a per-location basis, on a per-domain basis, etc., based on which failover configurations may be determined and implemented. A wireless network may include an NF, such as a NWDAF, that aggregates analytics information, such as operational status information, from various sources, and generates analytics reports that may be used (e.g., by NRF 501 and/or some other suitable NF) to identify NF instances that are available or unavailable, locations (e.g., geographical locations, datacenters, etc.) at which hardware resources implementing particular NF instances are available or unavailable, or the like. As discussed herein, this enhanced analytics information may be based on control plane monitoring by a controller, management platform, etc. associated with a containerization and/or virtualization platform that implements NFs (e.g., CNFs, VNFs, etc.), thus leveraging the capabilities of the controller or management platform to provide granular operational status information.

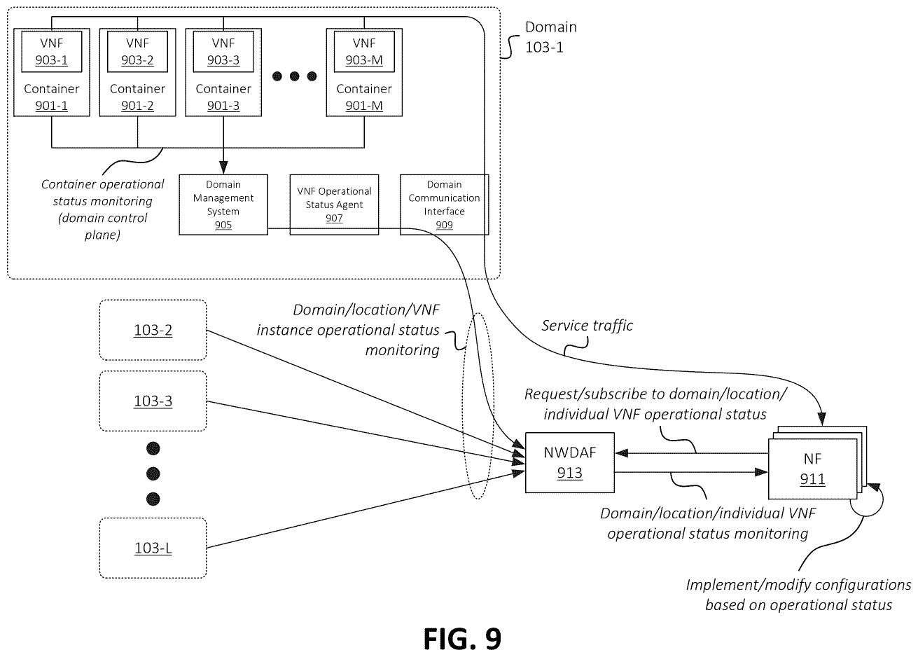

As shown in FIG. 9, for example, a particular domain 103-1 may include a set of containers 901 (e.g., example containers 901-1, 901-2, 901-3, 901-M, etc.). In the examples described herein, each respective container 901 may include, may implement, etc. a particular VNF instance 903 (referred to herein simply as “VNF 903” for the sake of brevity). For example, container 901-1 may include VNF 903-1, container 901-2 may include VNF 903-2, container 901-3 may include VNF 903-3, and container 901-M may include VNF 903-M. In one example, one or more VNFs 903 may be different types of NFs (e.g., VNF 903-1 may be a particular UPF instance, VNF 903-2 may be a particular CU instance, etc.). In some scenarios, one or more VNFs 903 may be separate instances of the same type of NF (e.g., VNF 903-1 may be a first UPF instance and VNF 903-2 may be a second UPF instance). In some implementations, one container 901 may include, may implement, etc. multiple VNFs 903. While referred to in the context of VNFs, similar concepts may apply to CNFs or NFs that are implemented or deployed in some other type of virtualized or containerized environment.

Each domain 103 may include a respective Domain Management System (“DMS”) 905, which may manage, provision, configure, etc. hardware resources of each domain 103 and respective containers 901 associated with such domains 103. For example, DMS 905 may provision hardware resources (e.g., processing resources, storage resources, memory resources, network resources, etc.) of domain 103-1 to implement containers 901, establish connectivity (e.g., network interfaces, APIs, etc.) for containers 901, configure containers 901 (e.g., by installing or instantiating particular containers or other suitable resources) to implement respective VNFs 903, and/or other suitable operations.

DMS 905 may communicate with each container 901 in order to manage, configure, monitor, etc. containers 901. Such communications may be referred to as “domain control plane” messaging, which may include messages associated with one or more protocols, APIs, routing mechanisms, etc. that facilitate the management, configuration, monitoring, etc. of containers 901 by DMS 905. In some embodiments, such protocols, APIs, routing mechanisms, etc. may be “internal” to domain 103, inasmuch as devices or systems that are external to domain 103 may not have access to, or may not be authorized to communicate with, containers 901 and/or DMS 905.

In one example, domain control plane messaging may include DMS 905 provisioning or allocating hardware resources on which a given container 901 may be implemented, installed, instantiated, etc. As another example, domain control plane messaging may include DMS 905 monitoring operational status information associated with one or more containers 901 and/or VNFs 903. For example, monitoring operational status of a given container 901 may determining an availability indication (e.g., “available” or “unavailable”) for a given container 901, performance or load metrics (e.g., latency, processor load, network load, etc.) associated with a given container 901, or other suitable operational status information. As discussed below, the operational status monitoring information may include operational status monitoring information associated with individual containers 901 and/or VNFs 903, based on which aggregated operational status information associated with a given domain 103, geographical location, or other type of aggregated information may be generated. Failover routing and/or priority configurations, such as determining particular NFs to set as primary and/or backup NFs as discussed above, may be determined based on such information.

DMS 905 may provide, forward, etc. some or all of the operational status monitoring information (e.g., associated with one or more containers 901 and/or VNFs 903) to VNF Operational Status Agent (“VOSA”) 907. In some embodiments, each domain 103 may include or may be associated with a particular VOSA 907. For example, in some embodiments, VOSA 907 may be implemented by one or more containers, devices, etc. that communicate with DMS 905 via the domain control plane of domain 103. In some embodiments, VOSA 907 may be external to domain 103, and may communicate with DMS 905 (and/or other elements of domain 103) via one or more interfaces, APIs, etc. that facilitate communications between elements of domain 103 and external devices or systems.

For example, each domain 103 may include Doman Communication Interface (“DCI”) 909, which may include one or more physical or virtual network interfaces, APIs, or other suitable communication pathways via which DMS 905 and/or containers 901 (e.g., VNFs 903) may communicate with devices, systems, or networks that are external to domain 103 (e.g., with other NFs 911 of a wireless network). For example, VNFs 903 of domain 103-1 may send and/or receive traffic to and/or from one or more NFs 911, such as service traffic. “Service traffic,” as used herein, may include user plane traffic such as traffic sent to or received from one or more UEs 111. Additionally, or alternatively, “service traffic” may refer to control plane traffic such as communication session management messages, mobility or handover messages, authentication or access messages, policy-based messages, or the like. While shown as separate elements in FIG. 9, NFs 911 may also be, may include, or may be implemented by VNFs 903. For example, a first NF 911 may include a first VNF 903, a second NF 911 may include a second VNF 903, and so on. For example, service traffic may be communicated (e.g., via respective DCIs 909 and/or other routing devices 503) between different domains 103. As noted above, service traffic may also be sent and received between VNFs 903 of the same domain 103. For example, service traffic that is communicated between VNFs 903 of the same domain 103 may exhibit less latency than service traffic that is communicate between VNFs 903 of different domains 103.

VOSA 907 may also provide operational status monitoring information, associated with VNFs 903, to NWDAF 913. In some embodiments, the operational status monitoring information may include operational status information for some or all VNFs 903 that are implemented at one or more domains 103. As discussed above, such operational status information may include an availability indication, performance and/or load information, “health” information, or other suitable information associated with VNFs 903. In some embodiments, for example, the operational status information for a given VNF 903 may include or may be based on operational status information associated with a respective container 901 that includes or implements VNF 903. For instance, operational status information for a particular container 901 may reflect or may indicate the operational status for a corresponding VNF 903. That is, if a particular container 901 is unavailable, is experiencing a performance degradation, etc., the corresponding VNF 903 may also be considered to be unavailable, experiencing a performance degradation, etc. In some embodiments, VOSA 907 may maintain information associating particular VNFs 903 with particular containers 901. In this sense, VOSA 907 may receive operational status information from DMS 905 on a per-container basis, and may identify corresponding operational status information for VNFs 903 (e.g., on a per-VNF instance basis).

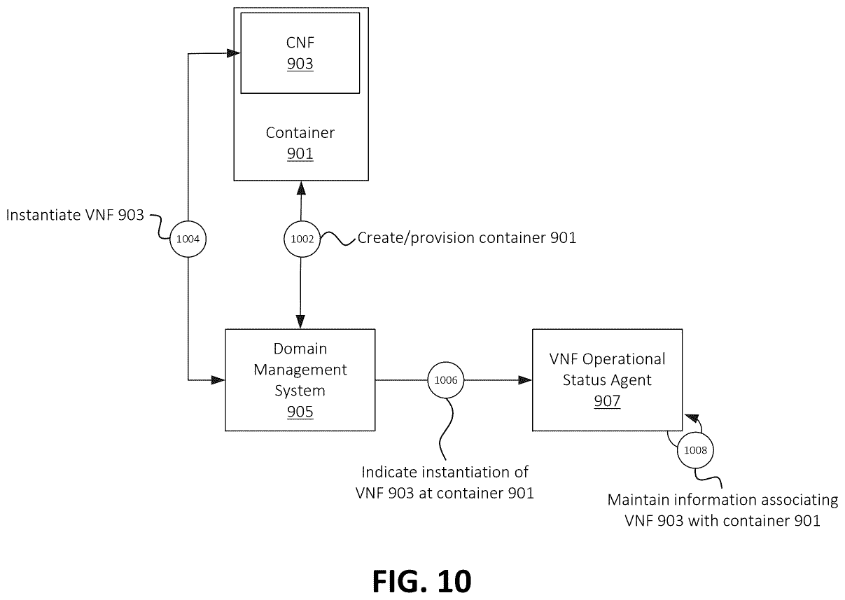

For example, as shown in FIG. 10, DMS 905 may create, provision, etc. (at 1002) a particular container 901. As discussed above, creating or provisioning container 901 may include provisioning, allocating, etc. hardware resources or other suitable resources for container 901, establishing connectivity (e.g., domain control plane messaging connectivity and/or other external connectivity) for container 901, and/or other suitable operations. In some embodiments, establishing connectivity for container 901 may include setting a hostname, container identifier, an IP address (e.g., in an address space internal to domain 103), or other suitable identifier of container 901, in order to establish domain control plane communications with container 901.

DMS 905 may further instantiate (at 1004) a particular VNF 903 at container 901. For example, DMS 905 may install one or more images, libraries, installation packages, or the like onto container 901. In some scenarios, DMS 905 may provision (at 1002) container 901 and/or instantiate (at 1004) VNF 903 based on a request, instruction, etc. from NMS 115 and/or some other suitable device or system.

DMS 905 may additionally indicate (at 1006) the instantiation of VNF 903 at container 901. For example, DMS 905 may “push” an indication, of the instantiation of VNF 903, to VOSA 907 or may provide the indication to VOSA 907 based on a request from VOSA 907. In some embodiments, for example, VOSA 907 may be authorized to receive indications of the instantiation of certain VNFs 903 (e.g., VNFs 903 with a particular label or marking, VNFs 903 associated with a particular mobile network operator (“MNO”), VNFs 903 associated with or deployed in a particular geographical region, VNFs 903 associated with or deployed in a particular datacenter, or VNFs 903 having other attributes), but may not be authorized to receive indications of the instantiation of other VNFs 903 (e.g., VNFs 903 without the particular label or marking, VNFs 903 associated with other MNOs, etc.). The indication may include an identifier of container 901 as well as an identifier of VNF 903 (e.g., an NF instance identifier or other suitable identifier). In this manner, VOSA 907 may be able to maintain (at 1008) information associating the particular VNF 903 with the particular container 901.

Additionally, VOSA 907 may receive (e.g., from DMS 905, from NMS 115, and/or some other suitable device or system) additional information associated with DMS 905 and/or its associated domain 103. For example, VOSA 907 may receive and maintain information associated with a geographical location or tracking area of DMS 905 and/or its associated domain 103, a domain identifier of domain 103, and/or some other suitable identifier of domain 103 and/or DMS 905. In this manner, VOSA 907 may further associate VNF 903 (e.g., implemented at container 901 of the same domain 103 of DMS 905) with a particular geographical location or tracking area, a particular domain 103, etc.

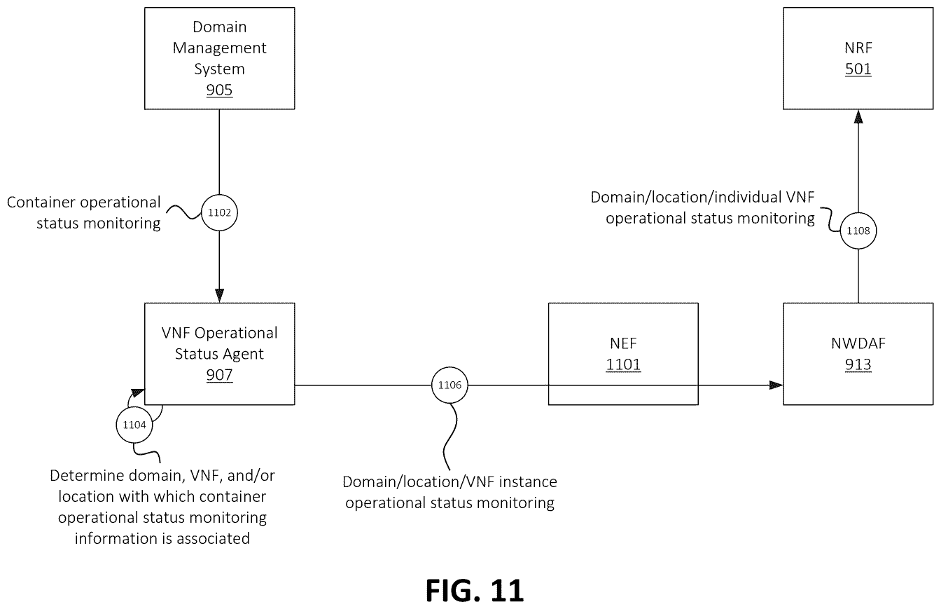

As shown in FIG. 11, for example, DMS 905 may provide (at 1102) operational status monitoring information, associated with one or more associated containers 901, to VOSA 907. In some embodiments, the operational status monitoring information, provided (at 1102) by DMS 905, may include a container identifier of one or more such containers 901. In some embodiments, the operational status monitoring information, provided (at 1102) by DMS 905, may omit (e.g., not include) an identifier of a respective VNF 903 that is installed, implemented by, etc. a respective container 901 with which the container operational status monitoring information is associated.

VOSA 907 may identify (at 1104) a particular domain 103, VNF 903, geographical location, and/or other information associated with the received container operational status information. For example, as discussed above, VOSA 907 may have previously received, or may otherwise identify, that a particular container 901 is associated with (e.g., implements) a particular VNF 903, is associated with a particular geographical location, etc.

VOSA 907 may provide (at 1106) operational status monitoring information to NWDAF 913. The operational status monitoring information, provided to NWDAF 913, may include alerts (e.g., an indication that a particular VNF 903 has become unavailable, an indication that a particular VNF 903 is exhibiting performance metrics that are below one or more performance thresholds, etc.), ongoing operational status monitoring information (e.g., periodic and/or intermittent performance and/or load information), and/or other suitable operational status monitoring information. For example, since VOSA 907 is “aware” of attributes of respective VNFs 903, such as geographical location or tracking area, VNF identifiers of VNFs 903, container identifiers of containers 901, domains with which respective VNFs 903 are associated, or the like, VOSA 907 may be able to report operational status monitoring information to NWDAF 913 on a per-VNF basis, a per-domain basis, a per-geographical location basis, or the like.

In some embodiments, VOSA 907 may communicate with NWDAF 913 via Network Exposure Function (“NEF”) 1101 or some other suitable device, API, or communication pathway. For example, VOSA 907 may be external to the core of a wireless network (e.g., a core network that includes NWDAF 913, one or more VNFs 903, NFs 911, etc.). VOSA 907 may be registered with NEF 1101, may participate in one or more authentication procedures with NEF 1101, etc. such that VOSA 907 is authorized to provide (at 1106) operational status monitoring information to NWDAF 913 via NEF 1101.

As noted in FIG. 9, one or more NFs 911 (e.g., “consumer” NFs) of the wireless network may subscribe to, request, etc. operational status information associated with one or more particular VNFs 903 (e.g., one or more particular VNF instances), one or more geographical locations, one or more domains 103, or the like. For example, in examples described above, and as shown in FIG. 11, NRF 501 may receive (at 1108) operational status monitoring information on a per-domain basis, a per-location basis, a per-VNF basis, or some other suitable basis. For example, NRF 501 may subscribe to, request, etc. operational status monitoring information for a particular VNF 903, for a particular geographical location, for a particular domain 103, or the like. In this manner, NRF 501 may receive operational status updates for VNFs 903 that are ultimately based on monitoring, at the container level (e.g., by DMS 905), of VNFs 903.

Such operational status monitoring (e.g., at the container level) may be performed in addition to, or in lieu of, example embodiments such as those described with respect to FIG. 6, in which different VNFs 903 (e.g., which may implement example CUs 107-1 and 107-2) provide operational status information to NRF 501. Monitoring the operational status of VNFs 903 at the container level may reduce messaging overhead (e.g., reduced messaging via DCI 909), such that network resources between DCI 909 and devices external to its associated domain 103 are conserved. Additionally, in situations where a failure of a particular container 901 occurs, DMS 905 may identify the failure faster (e.g., more quickly, or sooner) than an example implementation in which another NF 911 or VNF 903 (e.g., a “backup” NF 911 or VNF 903) identifies the failure of a respective VNF 903 implemented at the failed container 901.

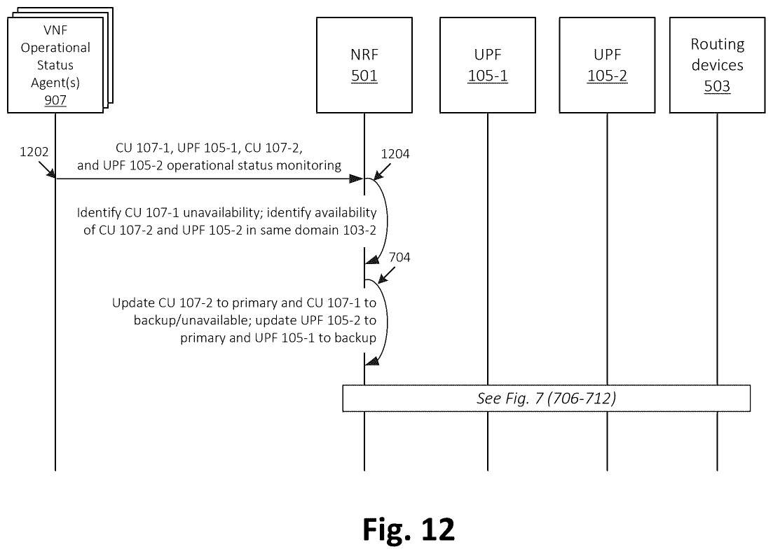

FIG. 12 illustrates a scenario similar to the one shown in FIG. 7, in which a particular VNF 903 (e.g., CU 107-1) fails, becomes unreachable, becomes unavailable, indicates an overload condition, and/or is otherwise unable to provide a given set of functionality (referred to herein as becoming “unavailable,” for the sake of conciseness). In the example of FIG. 12, NRF 501 may receive (at 1202) operational status monitoring information from one or more VOSAs 907 (e.g., which may each be associated with or communicatively coupled to one domain 103 or multiple domains 103). The operational status monitoring information may include operational status monitoring information for CU 107-1, UPF 105-1, CU 107-2, and UPF 105-2. Based on such operational status information, NRF 501 may identify (at 1204) that CU 107-1 has become unavailable. For example, the operational status monitoring information from VOSA 907 may include an unavailability indication, an indication of an overload, performance metrics which may be identified by NRF 501 as being below one or more thresholds, and/or may otherwise indicate that CU 107-1 is unavailable.

Similarly, NRF 501 may identify that a backup instance of CU 107-1 (e.g., CU 107-2) is available (e.g., is not unavailable, is not overloaded, etc.). Identifying that the backup instance for CU 107-2 is available may aid in avoiding scenarios in which the primary and backup instances have both failed, in which it may be inappropriate to attempt to failover CU 107-1 to its backup instance CU 107-2. In such scenarios, a different backup instance may be selected (e.g., a CU instance that has not failed, based on operational status monitoring information provided by VOSA(s) 907). NRF 501 may also identify that UPF 105-2, which is a backup to UPF 105-1 which is associated with failed CU 107-1, is available. A failover from CU 107-1 to CU 107-2, and a failover from UPF 105-1 to UPF 105-2, may accordingly be performed (e.g., similar to operations 704-712 discussed above with respect to FIG. 7) based on the operational status monitoring information provided by VOSA(s) 907 (e.g., operational status monitoring information that is based on container-level operational status monitoring).

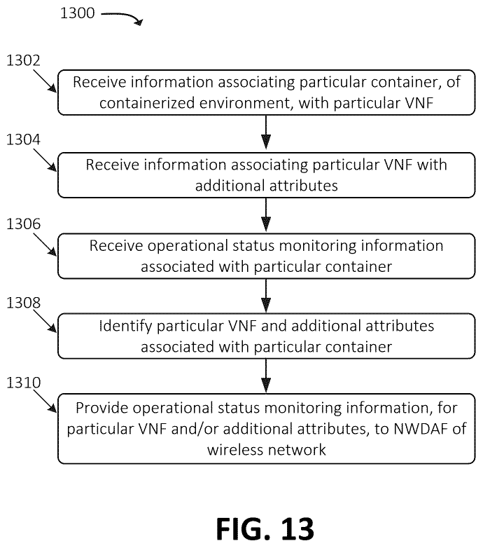

FIG. 13 illustrates an example process 1300 for providing operational status monitoring information, on a granular basis, to a wireless network (e.g., to NWDAF 913 of the wireless network). In some embodiments, some or all of process 1300 may be performed by VOSA 907.

As shown, process 1300 may include receiving (at 1302) and/or maintaining information associating a particular container 901, of a particular containerized environment (e.g., associated with a particular domain 103), with a particular VNF 903. For example, as discussed above, VOSA 907 may receive (e.g., from DMS 905 or some other suitable source) information indicating that a particular VNF 903 is associated with (e.g., is implemented by, has been installed on, etc.) a particular container 901.

Process 1300 may further include receiving (at 1304) and/or maintaining information associating VNF 903 with additional attributes. For example, as discussed above, VOSA 907 may receive additional information associated with VNF 903, container 901 on which VNF 903 is implemented, domain 103 with which container 901 and VNF 903 are associated, or the like. Such information may include geographical location information, tracking area information, domain identifier, an identifier or other indication of a datacenter with which domain 103 is associated, etc.

Process 1300 may additionally include receiving (at 1306) operational status monitoring information associated with the particular container 901. For example, as discussed above, VOSA 907 may receive container-level operational status monitoring information from DMS 905, which may be monitored by DMS 905 based on domain control plane communications or other suitable techniques (e.g., communication techniques that are internal to domain 103).

Process 1300 may also include identifying (at 1308) a particular VNF 903 associated with the particular container 901 (e.g., a VNF identifier, an instance identifier, etc.). In some embodiments, VOSA 907 may identify one or more of the additional attributes associated with the particular container 901 and/or VNF 903, as discussed above.

Process 1300 may further include providing (at 1310) operational status monitoring information, on a granular basis, to NWDAF 913. For example, VOSA 907 may provide operational status monitoring information associated with the particular VNF 903. In some embodiments, the operational status monitoring information may include information specifying some or all of the additional attributes associated with VNF 903, such as a geographical location of hardware resources at which VNF 903 is implemented, a tracking area that is served by or otherwise associated with VNF 903, an identifier of a datacenter in which hardware resources that implement VNF 903 are located, an identifier of domain 103 with which VNF 903 is associated, and/or other suitable information. As discussed above, consumer NFs 911, such as NRF 501 or other NFs 911, may communicate with NWDAF 913 in order to identify availability information associated with VNF 903 and/or other VNFs 903. As discussed above, performing failovers, such as coordinated failovers, may be performed based on the operational status monitoring information, which may include performing a coordinated failover of multiple NFs 911 that are associated with a first domain 103 to corresponding instances of such NFs 911 that are associated with a second domain 103.

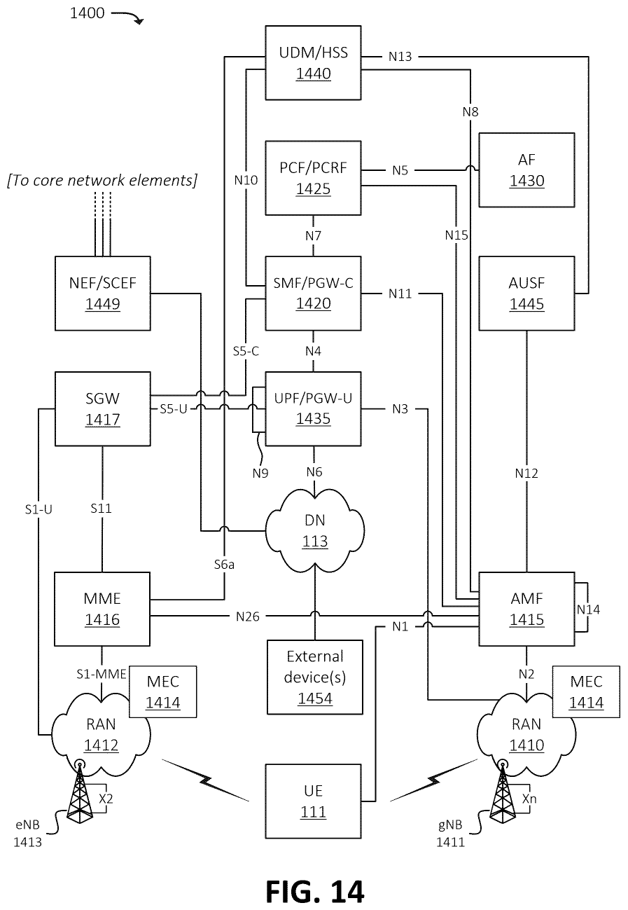

FIG. 14 illustrates an example environment 1400, in which one or more embodiments may be implemented. In some embodiments, environment 1400 may correspond to a Fifth Generation (“5G”) network, and/or may include elements of a 5G network. In some embodiments, environment 1400 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 1400 may represent or may include a 5G core (“5GC”). As shown, environment 1400 may include UE 111, RAN 1410 (which may include one or more Next Generation Node Bs (“gNBs”) 1411), RAN 1412 (which may include one or more evolved Node Bs (“eNBs”) 1414), and various network functions such as Access and Mobility Management Function (“AMF”) 1415, Mobility Management Entity (“MME”) 1416, Serving Gateway (“SGW”) 1417, Session Management Function (“SMF”)/Packet Data Network (“PDN”) Gateway (“PGW”)-Control plane function (“PGW-C”) 1420, Policy Control Function (“PCF”)/Policy Charging and Rules Function (“PCRF”) 1425, Application Function (“AF”) 1430, User Plane Function (“UPF”)/PGW-User plane function (“PGW-U”) 1435, Unified Data Management (“UDM”)/Home Subscriber Server (“HSS”) 1440, Authentication Server Function (“AUSF”) 1445, and NEF/Service Capability Exposure Function (“SCEF”) 14414. Environment 1400 may also include one or more networks, such as Data Network (“DN”) 114. Environment 1400 may include one or more additional devices or systems communicatively coupled to one or more networks (e.g., DN 113), such as one or more external devices 1454.

The example shown in FIG. 14 illustrates one instance of each network component or function (e.g., one instance of SMF/PGW-C 1420, PCF/PCRF 1425, UPF/PGW-U 1435, UDM/HSS 1440, and/or AUSF 1445). In practice, environment 1400 may include multiple instances of such components or functions. For example, in some embodiments, environment 1400 may include multiple “slices” of a core network, where each slice includes a discrete and/or logical set of network functions (e.g., one slice may include a first instance of AMF 1415, SMF/PGW-C 1420, PCF/PCRF 1425, and/or UPF/PGW-U 1435, while another slice may include a second instance of AMF 1415, SMF/PGW-C 1420, PCF/PCRF 1425, and/or UPF/PGW-U 1435). The different slices may provide differentiated levels of service, such as service in accordance with different Quality of Service (“QoS”) parameters.

The quantity of devices and/or networks, illustrated in FIG. 14, is provided for explanatory purposes only. In practice, environment 1400 may include additional devices and/or networks, fewer devices and/or networks, different devices and/or networks, or differently arranged devices and/or networks than illustrated in FIG. 14. For example, while not shown, environment 1400 may include devices that facilitate or enable communication between various components shown in environment 1400, such as routers, modems, gateways, switches, hubs, etc. In some implementations, one or more devices of environment 1400 may be physically integrated in, and/or may be physically attached to, one or more other devices of environment 1400. Alternatively, or additionally, one or more of the devices of environment 1400 may perform one or more network functions described as being performed by another one or more of the devices of environment 1400.

Additionally, one or more elements of environment 1400 may be implemented in a virtualized and/or containerized manner. For example, one or more of the elements of environment 1400 may be implemented by one or more VNFs 903, CNFs, etc. In such embodiments, environment 1400 may include, may implement, and/or may be communicatively coupled to an orchestration platform that provisions hardware resources, installs containers or applications, performs load balancing, and/or otherwise manages the deployment of such elements of environment 1400. In some embodiments, such orchestration and/or management of such elements of environment 1400 may be performed by, or in conjunction with, the open-source Kubernetes® application programming interface (“API”) or some other suitable virtualization, containerization, and/or orchestration system.

Elements of environment 1400 may interconnect with each other and/or other devices via wired connections, wireless connections, or a combination of wired and wireless connections. Examples of interfaces or communication pathways between the elements of environment 1400, as shown in FIG. 14, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 14, such as Service-Based Interfaces (“SBIs”), including an Namf interface, an Nudm interface, an Npcf interface, an Nupf interface, an Nnef interface, an Nsmf interface, and/or one or more other SBIs.

UE 111 may include a computation and communication device, such as a wireless mobile communication device that is capable of communicating with RAN 1410, RAN 1412, and/or DN 113. UE 111 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 111 may send traffic to and/or receive traffic (e.g., user plane traffic) from DN 113 via RAN 1410, RAN 1412, and/or UPF/PGW-U 1435.

RAN 1410 may be, or may include, a 5G RAN that implements a 5G RAT and that includes one or more base stations (e.g., one or more gNBs 1411), via which UE 111 may communicate with one or more other elements of environment 1400. UE 111 may communicate with RAN 1410 via an air interface (e.g., as provided by gNB 1411). For instance, RAN 1410 may receive traffic (e.g., user plane traffic such as voice call traffic, data traffic, messaging traffic, etc.) from UE 111 via the air interface, and may communicate the traffic to UPF/PGW-U 1435 and/or one or more other devices or networks. Further, RAN 1410 may receive signaling traffic, control plane traffic, etc. from UE 111 via the air interface, and may communicate such signaling traffic, control plane traffic, etc. to AMF 1415 and/or one or more other devices or networks. Additionally, RAN 1410 may receive traffic intended for UE 111 (e.g., from UPF/PGW-U 1435, AMF 1415, and/or one or more other devices or networks) and may communicate the traffic to UE 111 via the air interface.

RAN 1412 may be, or may include, an LTE RAN that implements an LTE RAT and that includes one or more base stations (e.g., one or more eNBs 1413), via which UE 111 may communicate with one or more other elements of environment 1400. UE 111 may communicate with RAN 1412 via an air interface (e.g., as provided by eNB 1413). For instance, RAN 1412 may receive traffic (e.g., user plane traffic such as voice call traffic, data traffic, messaging traffic, signaling traffic, etc.) from UE 111 via the air interface, and may communicate the traffic to UPF/PGW-U 1435 (e.g., via SGW 1417) and/or one or more other devices or networks. Further, RAN 1412 may receive signaling traffic, control plane traffic, etc. from UE 111 via the air interface, and may communicate such signaling traffic, control plane traffic, etc. to MME 1416 and/or one or more other devices or networks. Additionally, RAN 1412 may receive traffic intended for UE 111 (e.g., from UPF/PGW-U 1435, MME 1416, SGW 1417, and/or one or more other devices or networks) and may communicate the traffic to UE 111 via the air interface.

One or more RANs of environment 1400 (e.g., RAN 1410 and/or RAN 1412) may include, may implement, and/or may otherwise be communicatively coupled to one or more edge computing devices, such as one or more Multi-Access/Mobile Edge Computing (“MEC”) devices (referred to sometimes herein simply as a “MECs”) 1414. MECs 1414 may be co-located with wireless network infrastructure equipment of RANs 1410 and/or 1412 (e.g., one or more gNBs 1411 and/or one or more eNBs 1413, respectively). Additionally, or alternatively, MECs 1414 may otherwise be associated with geographical regions (e.g., coverage areas) of wireless network infrastructure equipment of RANs 1410 and/or 1412. In some embodiments, one or more MECs 1414 may be implemented by the same set of hardware resources, the same set of devices, etc. that implement wireless network infrastructure equipment of RANs 1410 and/or 1412. In some embodiments, one or more MECs 1414 may be implemented by different hardware resources, a different set of devices, etc. from hardware resources or devices that implement wireless network infrastructure equipment of RANs 1410 and/or 1412. In some embodiments, MECs 1414 may be communicatively coupled to wireless network infrastructure equipment of RANs 1410 and/or 1412 (e.g., via a high-speed and/or low-latency link such as a physical wired interface, a high-speed and/or low-latency wireless interface, or some other suitable communication pathway).

MECs 1414 may include hardware resources (e.g., configurable or provisionable hardware resources) that may be configured to provide services and/or otherwise process traffic to and/or from UE 111, via RAN 1410 and/or 1412. For example, RAN 1410 and/or 1412 may route some traffic from UE 111 (e.g., traffic associated with one or more particular services, applications, application types, etc.) to a respective MEC 1414 instead of to core network elements of 1400 (e.g., UPF/PGW-U 1435). MEC 1414 may accordingly provide services to UE 111 by processing such traffic, performing one or more computations based on the received traffic, and providing traffic to UE 111 via RAN 1410 and/or 1412. MEC 1414 may include, and/or may implement, some or all of the functionality described above with respect to UPF/PGW-U 1435, AF 1430, one or more application servers, and/or one or more other devices, systems, VNFs 903, CNFs, etc. In this manner, ultra-low latency services may be provided to UE 111, as traffic does not need to traverse links (e.g., backhaul links) between RAN 1410 and/or 1412 and the core network.

AMF 1415 may include one or more devices, systems, VNFs 903, CNFs, etc., that perform operations to register UE 111 with the 5G network, to establish bearer channels associated with a session with UE 111, to hand off UE 111 from the 5G network to another network, to hand off UE 111 from the other network to the 5G network, manage mobility of UE 111 between RANs 1410 and/or gNBs 1411, and/or to perform other operations. In some embodiments, the 5G network may include multiple AMFs 1415, which communicate with each other via the N14 interface (denoted in FIG. 14 by the line marked “N14” originating and terminating at AMF 1415).

MME 1416 may include one or more devices, systems, VNFs 903, CNFs, etc., that perform operations to register UE 111 with the EPC, to establish bearer channels associated with a session with UE 111, to hand off UE 111 from the EPC to another network, to hand off UE 111 from another network to the EPC, manage mobility of UE 111 between RANs 1412 and/or eNBs 1413, and/or to perform other operations.

SGW 1417 may include one or more devices, systems, VNFs 903, CNFs, etc., that aggregate traffic received from one or more eNBs 1413 and send the aggregated traffic to an external network or device via UPF/PGW-U 1435. Additionally, SGW 1417 may aggregate traffic received from one or more UPF/PGW-Us 1435 and may send the aggregated traffic to one or more eNBs 1413. SGW 1417 may operate as an anchor for the user plane during inter-eNB handovers and as an anchor for mobility between different telecommunication networks or RANs (e.g., RANs 1410 and 1412).

SMF/PGW-C 1420 may include one or more devices, systems, VNFs 903, CNFs, etc., that gather, process, store, and/or provide information in a manner described herein. SMF/PGW-C 1420 may, for example, facilitate the establishment of communication sessions on behalf of UE 111. In some embodiments, the establishment of communications sessions may be performed in accordance with one or more policies provided by PCF/PCRF 1425.

PCF/PCRF 1425 may include one or more devices, systems, VNFs 903, CNFs, etc., that aggregate information to and from the 5G network and/or other sources. PCF/PCRF 1425 may receive information regarding policies and/or subscriptions from one or more sources, such as subscriber databases and/or from one or more users (such as, for example, an administrator associated with PCF/PCRF 1425).

AF 1430 may include one or more devices, systems, VNFs 903, CNFs, etc., that receive, store, and/or provide information that may be used in determining parameters (e.g., quality of service parameters, charging parameters, or the like) for certain applications. In some embodiments, a particular AF 1430 may include, may implement, may be implemented by, or may be otherwise associated with a particular VOSA 907.

UPF/PGW-U 1435 may include one or more devices, systems, VNFs 903, CNFs, etc., that receive, store, and/or provide data (e.g., user plane data). For example, UPF/PGW-U 1435 may receive user plane data (e.g., voice call traffic, data traffic, etc.), destined for UE 111, from DN 113, and may forward the user plane data toward UE 111 (e.g., via RAN 1410, SMF/PGW-C 1420, and/or one or more other devices). In some embodiments, multiple instances of UPF/PGW-U 1435 may be deployed (e.g., in different geographical locations), and the delivery of content to UE 111 may be coordinated via the N9 interface (e.g., as denoted in FIG. 14 by the line marked “N9” originating and terminating at UPF/PGW-U 1435). Similarly, UPF/PGW-U 1435 may receive traffic from UE 111 (e.g., via RAN 1410, RAN 1412, SMF/PGW-C 1420, and/or one or more other devices), and may forward the traffic toward DN 113. In some embodiments, UPF/PGW-U 1435 may communicate (e.g., via the N4 interface) with SMF/PGW-C 1420, regarding user plane data processed by UPF/PGW-U 1435.

UDM/HSS 1440 and AUSF 1445 may include one or more devices, systems, VNFs 903, CNFs, etc., that manage, update, and/or store, in one or more memory devices associated with AUSF 1445 and/or UDM/HSS 1440, profile information associated with a subscriber. In some embodiments, UDM/HSS 1440 may include, may implement, may be communicatively coupled to, and/or may otherwise be associated with some other type of repository or database, such as a Unified Data Repository (“UDR”). AUSF 1445 and/or UDM/HSS 1440 may perform authentication, authorization, and/or accounting operations associated with one or more UEs 111 and/or one or more communication sessions associated with one or more UEs 111.

DN 113 may include one or more wired and/or wireless networks. For example, DN 113 may include an IP-based PDN, a wide area network (“WAN”) such as the Internet, a private enterprise network, and/or one or more other networks. UE 111 may communicate, through DN 113, with data servers, other UEs 111, and/or to other servers or applications that are coupled to DN 113. DN 113 may be connected to one or more other networks, such as a public switched telephone network (“PSTN”), a public land mobile network (“PLMN”), and/or another network. DN 113 may be connected to one or more devices, such as content providers, applications, web servers, and/or other devices, with which UE 111 may communicate.

External devices 1454 may include one or more devices or systems that communicate with UE 111 via DN 113 and one or more elements of 1400 (e.g., via UPF/PGW-U 1435). External devices 1454 may include, for example, DMS 905, VOSA 907, DCI 909, one or more application servers, content provider systems, web servers, or the like. External devices 1454 may, for example, implement “server-side” applications that communicate with “client-side” applications executed by UE 111. External devices 1454 may provide services to UE 111 such as gaming services, videoconferencing services, messaging services, email services, web services, and/or other types of services. Operations described above with respect to a given external device 1454 (e.g., in accordance with some embodiments) may be performed by a single device, by a cloud computing system, by one or more devices that implement a virtualized or containerized environment, a collection of devices, etc.

In some embodiments, external devices 1454 may communicate with one or more elements of environment 1400 (e.g., core network elements) via NEF/SCEF 1449. NEF/SCEF 1449 include one or more devices, systems, VNFs 903, CNFs, etc. that provide access to information, APIs, and/or other operations or mechanisms of one or more core network elements to devices or systems that are external to the core network (e.g., to external device 1454 via DN 113). NEF/SCEF 1449 may maintain authorization and/or authentication information associated with such external devices or systems, such that NEF/SCEF 1449 is able to provide information, that is authorized to be provided, to the external devices or systems. For example, a given external device 1454 may request particular information associated with one or more core network elements. NEF/SCEF 1449 may authenticate the request and/or otherwise verify that external device 1454 is authorized to receive the information, and may request, obtain, or otherwise receive the information from the one or more core network elements. In some embodiments, NEF/SCEF 1449 may include, may implement, may be implemented by, may be communicatively coupled to, and/or may otherwise be associated with a Security Edge Protection Proxy (“SEPP”), which may perform some or all of the functions discussed above. External device 1454 may, in some situations, subscribe to particular types of requested information provided by the one or more core network elements, and the one or more core network elements may provide (e.g., “push”) the requested information to NEF/SCEF 1449 (e.g., in a periodic or otherwise ongoing basis).

In some embodiments, external devices 1454 may communicate with one or more elements of RAN 1410 and/or 1412 via an API or other suitable interface. For example, a given external device 1454 may provide instructions, requests, etc. to RAN 1410 and/or 1412 to provide one or more services via one or more respective MECs 1414. In some embodiments, such instructions, requests, etc. may include QoS parameters, Service Level Agreements (“SLAs”), etc. (e.g., maximum latency thresholds, minimum throughput thresholds, etc.) associated with the services.

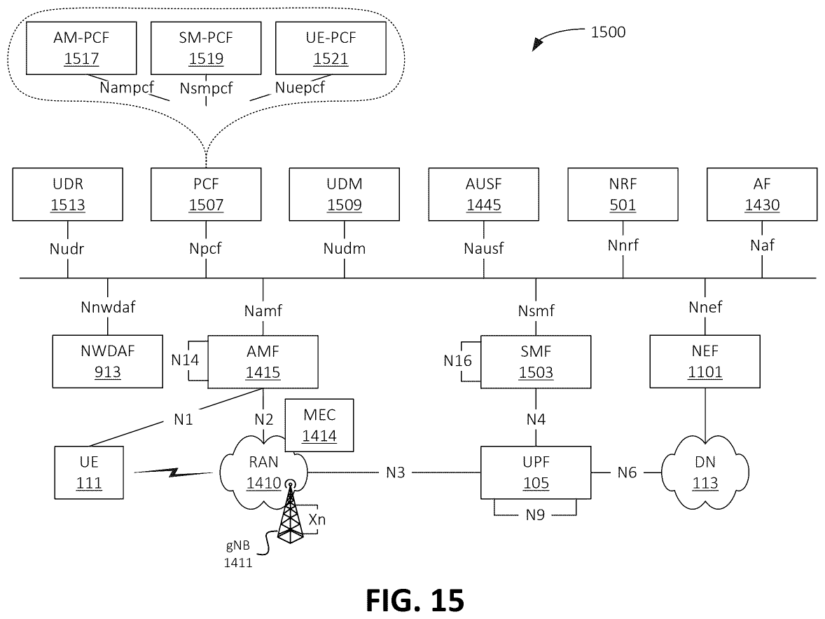

FIG. 15 illustrates another example environment 1500, in which one or more embodiments may be implemented. In some embodiments, environment 1500 may correspond to a 5G network, and/or may include elements of a 5G network. In some embodiments, environment 1500 may correspond to a 5G SA architecture. In some embodiments, environment 1500 may include a 5GC, in which 5GC network elements perform one or more operations described herein.

As shown, environment 1500 may include UE 111, RAN 1410 (which may include one or more gNBs 1411 or other types of wireless network infrastructure) and various network functions, which may be implemented as VNFs, CNFs, etc. Such network functions may include AMF 1415, SMF 1503, UPF 105, PCF 1507, UDM 1509, AUSF 1445, Network Repository Function (“NRF”) 501, AF 1430, UDR 1513, NWDAF 913, and NEF 1101. Environment 1500 may also include or may be communicatively coupled to one or more networks, such as DN 113.

The example shown in FIG. 15 illustrates one instance of each network component or function (e.g., one instance of SMF 1503, UPF 105, PCF 1507, UDM 1509, AUSF 1445, etc.). In practice, environment 1500 may include multiple instances of such components or functions. For example, in some embodiments, environment 1500 may include multiple “slices” of a core network, where each slice includes a discrete and/or logical set of network functions (e.g., one slice may include a first instance of SMF 1503, PCF 1507, UPF 105, etc., while another slice may include a second instance of SMF 1503, PCF 1507, UPF 105, etc.). Additionally, or alternatively, one or more of the network functions of environment 1500 may implement multiple network slices. The different slices may provide differentiated levels of service, such as service in accordance with different QoS parameters.

The quantity of devices and/or networks, illustrated in FIG. 15, is provided for explanatory purposes only. In practice, environment 1500 may include additional devices and/or networks, fewer devices and/or networks, different devices and/or networks, or differently arranged devices and/or networks than illustrated in FIG. 15. For example, while not shown, environment 1500 may include devices that facilitate or enable communication between various components shown in environment 1500, such as routers, modems, gateways, switches, hubs, etc. In some implementations, one or more devices of environment 1500 may be physically integrated in, and/or may be physically attached to, one or more other devices of environment 1500. Alternatively, or additionally, one or more of the devices of environment 1500 may perform one or more network functions described as being performed by another one or more of the devices of environment 1500.

Elements of environment 1500 may interconnect with each other and/or other devices via wired connections, wireless connections, or a combination of wired and wireless connections. Examples of interfaces or communication pathways between the elements of environment 1500, as shown in FIG. 15, may include interfaces shown in FIG. 15 and/or one or more interfaces not explicitly shown in FIG. 15. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1500 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1415), an Nudm interface (e.g., indicating communications to be routed to UDM 1509), an Npcf interface, an Nupf interface, an Nnef interface, an Nsmf interface, an Nnrf interface, an Nudr interface, an Naf interface, an Nnwdaf interface, and/or one or more other SBIs.

UPF 105 may include one or more devices, systems, VNFs 903, CNFs, etc., that receive, route, process, and/or forward traffic (e.g., user plane traffic). As discussed above, UPF 105 may communicate with UE 111 via one or more communication sessions, such as PDU sessions. Such PDU sessions may be associated with a particular network slice or other suitable QoS parameters, as noted above. UPF 105 may receive downlink user plane traffic (e.g., voice call traffic, data traffic, etc. destined for UE 111) from DN 113, and may forward the downlink user plane traffic toward UE 111 (e.g., via RAN 1410). In some embodiments, multiple UPFs 105 may be deployed (e.g., in different geographical locations), and the delivery of content to UE 111 may be coordinated via the N9 interface. Similarly, UPF 105 may receive uplink traffic from UE 111 (e.g., via RAN 1410), and may forward the traffic toward DN 113. In some embodiments, UPF 105 may implement, may be implemented by, may be communicatively coupled to, and/or may otherwise be associated with UPF/PGW-U 1435. In some embodiments, UPF 105 may communicate (e.g., via the N4 interface) with SMF 1503, regarding user plane data processed by UPF 105 (e.g., to provide analytics or reporting information, to receive policy and/or authorization information, etc.).

PCF 1507 may include one or more devices, systems, VNFs 903, CNFs, etc., that aggregate, derive, generate, etc. policy information associated with the 5GC and/or UEs 111 that communicate via the 5GC and/or RAN 1410. PCF 1507 may receive information regarding policies and/or subscriptions from one or more sources, such as subscriber databases (e.g., UDM 1509, UDR 1513, etc.), and/or from one or more users such as, for example, an administrator associated with PCF 1507. In some embodiments, the functionality of PCF 1507 may be split into multiple network functions or subsystems, such as access and mobility PCF (“AM-PCF”) 1517, session management PCF (“SM-PCF”) 1519, UE PCF (“UE-PCF”) 1521, and so on. Such different “split” PCFs may be associated with respective SBIs (e.g., AM-PCF 1517 may be associated with an Nampcf SBI, SM-PCF 1519 may be associated with an Nsmpcf SBI, UE-PCF 1521 may be associated with an Nuepcf SBI, and so on) via which other network functions may communicate with the split PCFs. The split PCFs may maintain information regarding policies associated with different devices, systems, and/or network functions.

NRF 501 may include one or more devices, systems, VNFs 903, CNFs, etc. that maintain routing and/or network topology information associated with the 5GC. For example, NRF 501 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1513 may include one or more devices, systems, VNFs 903, CNFs, etc. that provide user and/or subscriber information, based on which PCF 1507 and/or other elements of environment 1500 may determine access policies, QoS policies, charging policies, or the like. In some embodiments, UDR 1513 may receive such information from UDM 1509 and/or one or more other sources.

NEF 1101 include one or more devices, systems, VNFs 903, CNFs, etc. that provide access to information, APIs, and/or other operations or mechanisms of the 5GC to devices or systems that are external to the 5GC. NEF 1101 may maintain authorization and/or authentication information associated with such external devices or systems, such that NEF 1101 is able to provide information, that is authorized to be provided, to the external devices or systems. Such information may be received from other network functions of the 5GC (e.g., as authorized by an administrator or other suitable entity associated with the 5GC), such as SMF 1503, UPF 105, a charging function (“CHF”) of the 5GC, and/or other suitable network function. NEF 1101 may communicate with external devices or systems (e.g., external devices 1454) via DN 113 and/or other suitable communication pathways.

While environment 1500 is described in the context of a 5GC, as noted above, environment 1500 may, in some embodiments, include or implement one or more other types of core networks. For example, in some embodiments, environment 1500 may be or may include a converged packet core, in which one or more elements may perform some or all of the functionality of one or more 5GC network functions and/or one or more EPC network functions. For example, in some embodiments, AMF 1415 may include, may implement, may be implemented by, and/or may otherwise be associated with MME 1416; SMF 1503 may include, may implement, may be implemented by, and/or may otherwise be associated with SGW 1417; PCF 1507 may include, may implement, may be implemented by, and/or may otherwise be associated with a PCRF (e.g., PCF/PCRF 1425); NEF 1101 may include, may implement, may be implemented by, and/or may otherwise be associated with a SCEF (e.g., NEF/SCEF 1449); and so on.

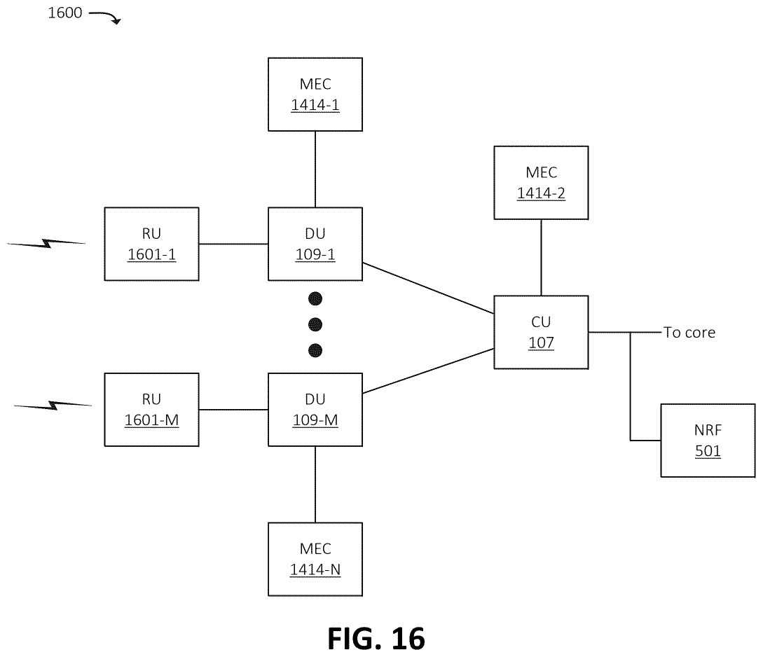

FIG. 16 illustrates an example RAN environment 1600, which may be included in and/or implemented by one or more RANs (e.g., RAN 1410 or some other RAN). In some embodiments, a particular RAN 1410 may include one RAN environment 1600. In some embodiments, a particular RAN 1410 may include multiple RAN environments 1600. In some embodiments, RAN environment 1600 may correspond to a particular gNB 1411 of RAN 1410. In some embodiments, RAN environment 1600 may correspond to multiple gNBs 1411. In some embodiments, RAN environment 1600 may correspond to one or more other types of base stations of one or more other types of RANs. As shown, RAN environment 1600 may include CU 107, one or more DUs 109-1 through 109-M (referred to individually as “DU 109,” or collectively as “DUs 109”), and one or more Radio Units (“RUs”) 1601-1 through 1601-M (referred to individually as “RU 1601,” or collectively as “RUs 1601”).

CU 107 may communicate with a core of a wireless network (e.g., may communicate with one or more of the devices or systems described above with respect to FIG. 15, such as AMF 1415 and/or UPF 105) and/or some other device or system such as MEC 1414. In the uplink direction (e.g., for traffic from UEs 111 to a core network), CU 107 may aggregate traffic from DUs 109, and forward the aggregated traffic to the core network. In some embodiments, CU 107 may receive traffic according to a given protocol (e.g., Radio Link Control (“RLC”) traffic) from DUs 109, and may perform higher-layer processing (e.g., may aggregate/process RLC packets and generate Packet Data Convergence Protocol (“PDCP”) packets based on the RLC packets) on the traffic received from DUs 109.

CU 107 may receive downlink traffic (e.g., traffic from the core network, traffic from a given MEC 1414, etc.) for a particular UE 111, and may determine which DU(s) 109 should receive the downlink traffic. DU 109 may include one or more devices that transmit traffic between a core network (e.g., via CU 107) and UE 111 (e.g., via a respective RU 1601). DU 109 may, for example, receive traffic from RU 1601 at a first layer (e.g., physical (“PHY”) layer traffic, or lower PHY layer traffic), and may process/aggregate the traffic to a second layer (e.g., upper PHY and/or RLC). DU 109 may receive traffic from CU 107 at the second layer, may process the traffic to the first layer, and provide the processed traffic to a respective RU 1601 for transmission to UE 111.

RU 1601 may include hardware circuitry (e.g., one or more RF transceivers, antennas, radios, and/or other suitable hardware) to communicate wirelessly (e.g., via an RF interface) with one or more UEs 111, one or more other DUs 109 (e.g., via RUs 1601 associated with DUs 109), and/or any other suitable type of device. In the uplink direction, RU 1601 may receive traffic from UE 111 and/or another DU 109 via the RF interface and may provide the traffic to DU 109. In the downlink direction, RU 1601 may receive traffic from DU 109, and may provide the traffic to UE 111 and/or another DU 109.

One or more elements of RAN environment 1600 may, in some embodiments, be communicatively coupled to one or more MECs 1414. For example, DU 109-1 may be communicatively coupled to MEC 1414-1, DU 109-M may be communicatively coupled to MEC 1414-N, CU 107 may be communicatively coupled to MEC 1414-2, and so on. MECs 1414 may include hardware resources (e.g., configurable or provisionable hardware resources) that may be configured to provide services and/or otherwise process traffic to and/or from UE 111, via a respective RU 1601.

For example, DU 109-1 may route some traffic, from UE 111, to MEC 1414-1 instead of to a core network via CU 107. MEC 1414-1 may process the traffic, perform one or more computations based on the received traffic, and may provide traffic to UE 111 via RU 1601-1. As discussed above, MEC 1414 may include, and/or may implement, some or all of the functionality described above with respect to UPF 105, AF 1430, and/or one or more other devices, systems, VNFs 903, CNFs, etc. In this manner, ultra-low latency services may be provided to UE 111, as traffic does not need to traverse DU 109, CU 107, links between DU 109 and CU 107, and an intervening backhaul network between RAN environment 1600 and the core network.

In some embodiments, RAN environment 1600 may represent a particular domain 103, a particular tracking area 101, and/or portions thereof. For example, FIG. 16 may depict a particular CU instance out of multiple CU instances of a given domain 103 or a given tracking area 101. As discussed above, CUs 107 may be communicatively coupled to NRF 501 and/or one or more other core network NFs. CUs 107 may communicate with NRF 501 to perform some or all of the operations described above, in accordance with some embodiments.

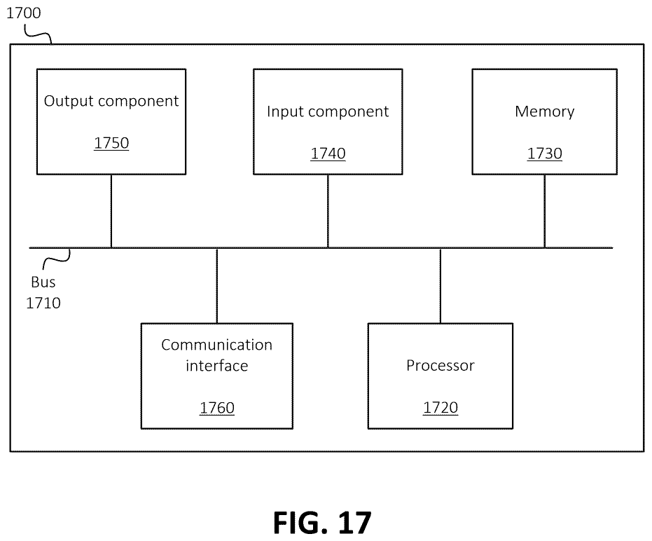

FIG. 17 illustrates example components of device 1700. One or more of the devices described above may include one or more devices 1700. Device 1700 may include bus 1710, processor 1720, memory 1730, input component 1740, output component 1750, and communication interface 1760. In another implementation, device 1700 may include additional, fewer, different, or differently arranged components.

Bus 1710 may include one or more communication paths that permit communication among the components of device 1700. Processor 1720 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1720 may be or may include one or more hardware processors. Memory 1730 may include any type of dynamic storage device that may store information and instructions for execution by processor 1720, and/or any type of non-volatile storage device that may store information for use by processor 1720.

Input component 1740 may include a mechanism that permits an operator to input information to device 1700 and/or other receives or detects input from a source external to input component 1740, such as a touchpad, a touchscreen, a keyboard, a keypad, a button, a switch, a microphone or other audio input component, etc. In some embodiments, input component 1740 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1750 may include a mechanism that outputs information to the operator, such as a display, a speaker, one or more light emitting diodes (“LEDs”), etc.

Communication interface 1760 may include any transceiver-like mechanism that enables device 1700 to communicate with other devices and/or systems (e.g., via RAN 1410, RAN 1412, DN 113, etc.). For example, communication interface 1760 may include an Ethernet interface, an optical interface, a coaxial interface, or the like. Communication interface 1760 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1700 may include more than one communication interface 1760. For instance, device 1700 may include an optical interface, a wireless interface, an Ethernet interface, and/or one or more other interfaces.

Device 1700 may perform certain operations relating to one or more processes described above. Device 1700 may perform these operations in response to processor 1720 executing instructions, such as software instructions, processor-executable instructions, etc. stored in a computer-readable medium, such as memory 1730. A computer-readable medium may be defined as a non-transitory memory device. A memory device may include space within a single physical memory device or spread across multiple physical memory devices. The instructions may be read into memory 1730 from another computer-readable medium or from another device. The instructions stored in memory 1730 may be processor-executable instructions that cause processor 1720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
identify an association between a particular container, of a containerized environment, with a particular Virtualized Network Function (“VNF”) of a wireless network;
receive, via a control plane of the containerized environment, operational status monitoring information associated with the particular container;
generate operational status monitoring information associated with the particular VNF based on the operational status monitoring information associated with the particular container; and
output the operational status monitoring information, associated with the particular VNF, to an analytics element of the wireless network, wherein the analytics element provides the operational status monitoring information, associated with the particular VNF, to one or more other NFs of the wireless network.

2. The device of claim 1, wherein the analytics element of the wireless network includes a Network Data Analytics Function (“NWDAF”).

3. The device of claim 1, wherein the one or more other NFs include a Network Repository Function (“NRF”).

4. The device of claim 3, wherein the particular VNF includes a first instance of a Centralized Unit (“CU”), wherein the NRF modifies first priority information associated with the first instance of the CU based on the operational status monitoring information, and wherein the NRF further modifies second priority information associated with a second instance of the CU based on the operational status monitoring information.

5. The device of claim 1, wherein the one or more processors are further configured to:
receive location information associated with the particular container, wherein outputting the operational status monitoring information associated with the particular VNF further includes outputting the location information of the particular container.

6. The device of claim 1, wherein the containerized environment includes a controller that configures particular container, wherein configuring the particular container includes communicating with the particular container via the control plane of the containerized environment.

7. The device of claim 1, wherein the containerized environment includes a communication interface via which devices external to the containerized environment communicate with the particular container, wherein the communication interface is separate from the control plane of the containerized environment.

8. A non-transitory computer-readable medium, storing a plurality of processor-executable instructions to:
identify an association between a particular container, of a containerized environment, with a particular Virtualized Network Function (“VNF”) of a wireless network;
receive, via a control plane of the containerized environment, operational status monitoring information associated with the particular container;
generate operational status monitoring information associated with the particular VNF based on the operational status monitoring information associated with the particular container; and
output the operational status monitoring information, associated with the particular VNF, to an analytics element of the wireless network, wherein the analytics element provides the operational status monitoring information, associated with the particular VNF, to one or more other NFs of the wireless network.

9. The non-transitory computer-readable medium of claim 8, wherein the analytics element of the wireless network includes a Network Data Analytics Function (“NWDAF”).

10. The non-transitory computer-readable medium of claim 8, wherein the one or more other NFs include a Network Repository Function (“NRF”).

11. The non-transitory computer-readable medium of claim 10, wherein the particular VNF includes a first instance of a Centralized Unit (“CU”), wherein the NRF modifies first priority information associated with the first instance of the CU based on the operational status monitoring information, and wherein the NRF further modifies second priority information associated with a second instance of the CU based on the operational status monitoring information.

12. The non-transitory computer-readable medium of claim 8, wherein the plurality of processor-executable instructions further include processor-executable instructions to:
receive location information associated with the particular container, wherein outputting the operational status monitoring information associated with the particular VNF further includes outputting the location information of the particular container.

13. The non-transitory computer-readable medium of claim 8, wherein the containerized environment includes a controller that configures particular container, wherein configuring the particular container includes communicating with the particular container via the control plane of the containerized environment.

14. The non-transitory computer-readable medium of claim 8, wherein the containerized environment includes a communication interface via which devices external to the containerized environment communicate with the particular container, wherein the communication interface is separate from the control plane of the containerized environment.

15. A method, comprising:
identifying an association between a particular container, of a containerized environment, with a particular Virtualized Network Function (“VNF”) of a wireless network;
receiving, via a control plane of the containerized environment, operational status monitoring information associated with the particular container;
generating operational status monitoring information associated with the particular VNF based on the operational status monitoring information associated with the particular container; and
outputting the operational status monitoring information, associated with the particular VNF, to an analytics element of the wireless network, wherein the analytics element provides the operational status monitoring information, associated with the particular VNF, to one or more other NFs of the wireless network.

16. The method of claim 15, wherein the analytics element of the wireless network includes a Network Data Analytics Function (“NWDAF”).

17. The method of claim 15, wherein the one or more other NFs include a Network Repository Function (“NRF”), wherein the particular VNF includes a first instance of a Centralized Unit (“CU”), wherein the NRF modifies first priority information associated with the first instance of the CU based on the operational status monitoring information, and wherein the NRF further modifies second priority information associated with a second instance of the CU based on the operational status monitoring information.

18. The method of claim 15, further comprising:
receiving location information associated with the particular container, wherein outputting the operational status monitoring information associated with the particular VNF further includes outputting the location information of the particular container.

19. The method of claim 15, wherein the containerized environment includes a controller that configures particular container, wherein configuring the particular container includes communicating with the particular container via the control plane of the containerized environment.

20. The method of claim 15, wherein the containerized environment includes a communication interface via which devices external to the containerized environment communicate with the particular container, wherein the communication interface is separate from the control plane of the containerized environment.
